(19) United States
(12) Patent Application Publication
(10) Pub. No.: US 2016/0107928 A1
(43) Pub. Date: Apr. 21, 2016

(54) GLASS-FILM LAMINATES WITH CONTROLLED FAILURE STRENGTH

(71) Applicant: Corning Incorporated, Corning, NY (US)

(72) Inventors: John Frederick Bayne, Elmira, NY (US); Zhanjun Gao, Rochester, NY (US); Shandon Dee Hart, Corning, NY (US); Guangli Hu, Berkeley Heights, NJ (US); James Joseph Price, Corning, NY (US); Franklin Kumar Saha, Franklin, MI (US)

(21) Appl. No.: 14/891,917

(22) PCT Filed: May 21, 2014
(86) PCT No.: PCT/US2014/038912

§ 371 Date: Nov. 17, 2015

Related U.S. Application Data
(60) Provisional application No. 61/826,816, filed on May 23, 2013.

(51) Int. Cl. C03C 17/09; C03C 17/245

(52) U.S. Cl. CPC C03C 17/09; C03C 17/245

(57) ABSTRACT

A glass-film laminate or article having a narrow failure distribution or a Weibull modulus of greater than 10. In embodiments, the glass-film laminate or article includes at least one first film disposed on a strengthened glass substrate. A first film or any additional films can exhibit an average strain-to-failure that is less than the strain-to-failure of the strengthened glass substrate. In embodiments, the first film is adhered to the glass substrate such that the first film does not exhibit visible delamination from the glass substrate. Methods of forming glass-film laminates or articles with a desired strength level and narrow failure strength distribution are also disclosed.

This application claims the benefit of priority under 35 U.S.C. §119 of U.S. Provisional Application Ser. No. 61/826,816 filed on May 23, 2013, the content of which is relied upon and incorporated herein by reference in its entirety.

### BACKGROUND

The disclosure relates to glass-film laminates or articles that exhibit well-controlled failure strength, and more particularly to glass-film laminates that include a strengthened glass substrate and a film disposed on the strengthened glass substrate and that exhibit a Weibull modulus of greater than 10, as described herein.

Strengthened glass substrates are widely used as protective cover glass for various display applications, including touch-screen applications. Many other potential applications, such as automotive or architectural windows, glass substrates for photovoltaics, and others known in the art may incorporate strengthened glass substrates. Some applications, such as automotive windows, may have varied failure strength and failure strength distribution requirements for passenger safety where breakage should happen at a controlled and repeatable impact or flexural loading condition.

The failure strength distribution of strengthened glass substrates is generally modeled as being determined by the flaw size distribution. Under flexural loading conditions, based upon weakest link theory, the largest flaw in the glass substrate is activated to cause the catastrophic failure. Due to variations in processing capabilities, the largest flaw preexisting in the glass substrate surface can vary significantly, leading to large failure strength variations. This variation can be illustrated in Weibull probability plots. Weibull probability plots are a well-accepted statistical way to represent the strength distribution of brittle materials, such as glass. The Weibull modulus is a dimensionless shape parameter of the Weibull distribution function and is used to describe variability in measured material strength of brittle materials. Weibull modulus is the slope of the line drawn along data points on a Weibull probability plot. A higher Weibull modulus suggests narrow strength variation from sample to sample and a lower Weibull modulus suggests wide strength variation from sample to sample. For typical pristine strengthened glass substrates, the Weibull modulus is around 5 or less, and the Weibull modulus can occasionally go up to 10, if the surface of the strengthened glass substrate is very well protected.

In many practical applications, it can be advantageous to combine some type of film(s) with the strengthened glass substrate to form glass-film laminates. Such films may include semiconducting layers such as indium tin oxide (“ITO”) or other transparent conductive oxides, hard coating layers of various kinds, IR or UV blocking layers, conducting layers, electronics layers, thin-film-transistor layers and anti-reflection layers. Many of these films include hard and brittle materials. In many cases, the film can be hard and brittle to maintain one or more desirable functional properties (e.g., durability, electrical conductivity, optical properties, or thermal properties).

There is a need for glass-film laminates, including strengthened glass substrates and hard and brittle films, that exhibit a failure strength that can be tuned and is more narrowly distributed as compared to bare glass substrates. In addition, there is a need for a method for tuning the failure strength of such glass-film laminates to a desired level required for a given application, without making direct changes to the glass composition, structure or properties. For some applications, such as window applications, it may be desirable for such glass-film laminates to embody high optical transmission, low optical distortion, or both, which can include low optical scattering.

### SUMMARY

A first aspect of the present disclosure pertains to a glass-film laminate or article exhibiting a Weibull modulus of greater than about 10, or alternatively, 15 or greater, 30 or greater, or even 50 or greater, as measured by one of ring-on-ring testing, 4-point bend testing and 3-point bend testing. As used herein, the terms “glass-film laminate” and “article” may be used interchangeably. In one variant, the glass-film laminate may exhibit an optical transmittance of at least about 20%, over a portion of the visible wavelength range. In another variant, the glass-film laminate may exhibit an optical transmission haze of about 10% or less over the thickness of the glass-film laminate. In embodiments, the glass-film laminate may exhibit an asymmetric flexural strength, an asymmetric impact resistance or a combination thereof.

In embodiments, the glass-film laminate includes a strengthened glass substrate having a first and second major surface and a film disposed on the first major surface that forms an interface with the strengthened glass substrate. The interface may exhibit an interfacial fracture toughness that is greater than about 50% of the fracture toughness of the strengthened glass substrate.

In embodiments, during flexural loading of the glass-film laminate, the film may exhibit a total stress sufficient to bridge cracks present in the film across the interface and into the strengthened glass substrate. Optionally, the film may be adhered to the strengthened glass substrate such that the film does not exhibit visible delamination from the strengthened glass substrate, when observed under an optical microscope after indentation with a Berkovich diamond indenter using a non-zero load of up to about 40 grams.

In embodiments, the film may have a thickness of at least 10 nm. The film may exhibit an average strain-to-failure that is less than the strain-to-failure of the strengthened glass substrate, which may be greater than about 1% at the substrate surface. The film may also exhibit a fracture toughness of about 10 MPa·m^{1/2} or less, a critical strain energy release rate (G_{IC}=K_{IC}²/E) of less than about 1 kJ/m², or both. In specific embodiments, the critical strain energy release rate of the film can be about 0.5 kJ/m² or less, or even about 0.1 kJ/m² or less.

The glass-film laminate can include an additional film. In embodiments, the film or the additional film can include one or more layers, such as an IR blocking layer, a UV blocking layer, a conducting layer, a semiconducting layer, an electronics layer, a thin-film-transistor layer, a touch-sensing layer, an image-display layer, a fluorescent layer, a phosphorescent layer, a light-emitting layer, a wavelength-selective reflecting layer, a heads-up display layer, a scratch-resistant layer, an anti-reflection layer, an anti-glare layer, a dirt-resistant layer, a self-cleaning layer, a barrier layer, a passivation layer, a hermetic layer, a diffusion-blocking layer, a fingerprint resistant layer, or combinations thereof. The film or the additional films can include, for example, oxides, oxynitrides, nitrides, carbides, siliceous polymers, semiconductors, transparent conductors, metals or combinations thereof. In embodiments, the film may include at least one layer having a uniform composition throughout the layer. The film and the additional film may form a stack, which exhibits a fracture toughness of about 10 MPa·m^{1/2} or less. The film or the additional films may be disposed, for example, via a vacuum-based technique, a liquid-based technique, or combinations thereof.

A second aspect of the present disclosure pertains to a method of forming a glass-film laminate, as described herein. In embodiments, the method includes selecting a desired failure strength for the glass-film laminate, providing a chemically strengthened glass substrate, disposing a film on a first major surface of the strengthened glass substrate and controlling one or more of the film modulus, film thickness, and film residual stress to achieve the desired failure strength. In specific embodiments, the method includes controlling the film modulus, while providing a fixed film thickness, a fixed residual stress, or both. In embodiments, the method includes controlling the thickness of the film, while providing a fixed film Young's modulus, a fixed film residual stress, or both. In yet another embodiment, the method may include controlling the residual stress of the film, while providing a fixed film Young's modulus, a fixed film thickness, or both. Optionally, the method may include controlling two of the film thickness, the film residual stress, and the film Young's modulus.

In embodiments, the method includes forming an interface between the film and the strengthened glass substrate, such that the interface exhibits a fracture toughness that is greater than about 50% of the fracture toughness of the strengthened glass substrate. Optionally, the method may include cleaning (e.g., wet-cleaning or plasma cleaning) the first major surface of the strengthened glass substrate before disposing the film on the first major surface.

Additional features and advantages will be set forth in the detailed description.

It is to be understood that both the foregoing general description and the following detailed description are merely exemplary, and are intended to provide an overview or framework to understanding the nature and character of the claims. The drawings illustrate embodiment(s), and together with the description serve to explain principles and operation of the various embodiments.

### BRIEF DESCRIPTION OF THE DRAWINGS

In embodiments of the disclosure:

FIG. 1 illustrates a glass-film laminate.

FIG. 1A illustrates a glass-film laminate.

FIG. 2 illustrates a glass-film laminate.

FIG. 3 illustrates a glass-film laminate.

FIG. 4 illustrates a glass-film laminate.

FIG. 5 is a Weibull probability plot based on ring-on-ring test results of Examples 1A-1D.

FIG. 6 is a Weibull probability plot based on ring-on-ring test results of Examples 2A-2D.

FIG. 7 is a Weibull probability plot based on ring-on-ring test results of Examples 3A-3B.

FIG. 8 is a Weibull probability plot based on ring-on-ring test results of Examples 4A-4D.

FIG. 9 is a Weibull probability plot based on ring-on-ring test results of Examples 5A-5C.

FIG. 10 illustrates the bending strength of glass-film laminates.

### DETAILED DESCRIPTION

Reference will now be made in detail to the present preferred embodiment(s), an examples illustrated in the accompanying drawings.

A first aspect of this disclosure pertains to glass-film laminates having well controlled failure strength and exhibit a Weibull modulus of greater than about 10, or even greater than 20. In embodiments, the glass-film laminate exhibits a Weibull modulus of at least 15, at least 20, at least 25, at least 30, at least 35, at least 40, at least 45, at least 50, at least 55, at least 60, or at least 65, including all ranges and sub-ranges therebetween. In specific embodiments, the glass-film laminate exhibits a Weibull modulus in the range from about 15 to about 65, from about 15 to about 60, from about 15 to about 55, from about 15 to about 50, from about 15 to about 45, from about 15 to about 40, from about 15 to about 35, from about 20 to about 65, from about 25 to about 65, from about 30 to about 65, from about 35 to about 65, from about 36 to about 50, from about 38 to about 50, from about 40 to about 50, from about 42 to about 50, from about 44 to about 50, from about 46 to about 50, or from about 48 to about 50, including all ranges and sub-ranges therebetween. Weibull probability plots used herein to illustrate the Weibull modulus values specifically plot load to failure (kgf) versus failure probability for ring-on-ring test loading configurations. Ring-on-ring testing relates the surface strength of the glass-film laminate. Where improved edge strength of the glass-film laminate is desired, other types of testing or loading geometries or methods (including but not limited to ball drop testing, ball-on-ring testing, 4-point bend testing, 3-point bend testing, and others known in the art) can also be used to produce Weibull probability plots and Weibull modulus values. The Weibull modulus values may vary somewhat based on test conditions, without departing from the disclosure. A sample population of at least 10 identical glass-film laminates can be used to determine the Weibull modulus of the glass-film laminate.

As used herein, the term “failure strength” includes characteristic failure strength of a Weibull distribution, the average failure strength of a given number or sample of glass-film laminates, the average failure strength of a single glass-film laminate, or combinations thereof. The failure strength can be measured through methods such as ring-on-ring, ball-on-ring, or ball drop testing. Characteristic failure strength may refer to the scale parameter of two parameter Weibull statistics of failure load under ring-on-ring or ball-on-ring testing. This scale parameter may also be referred to as the Weibull characteristic strength, at which a brittle material's failure probability is 63.2%. Where failure strength is measured by a ball drop test, the failure strength of the glass-film laminate is characterized by a ball drop height that can be tolerated without failure. In some instances, failure strength may also include strength as tested by other methods known in the art, such as 3-point bend or 4-point bend testing. In some cases, these test methods may be significantly influenced by the edge strength of the laminate or the article being tested.

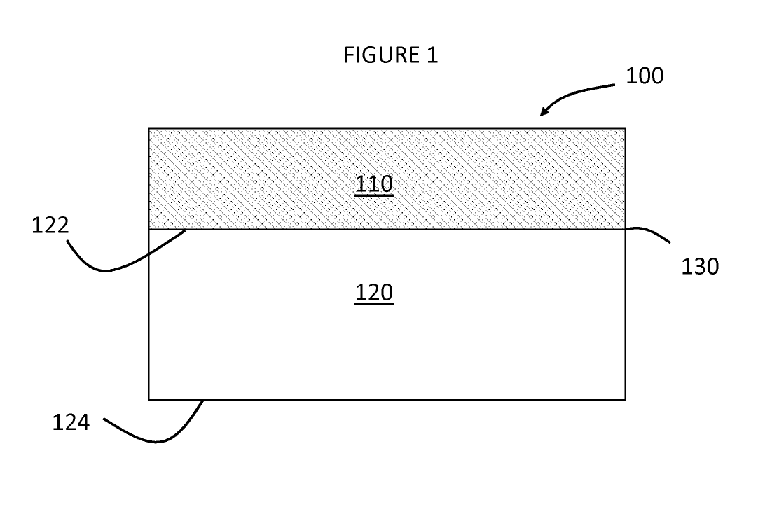

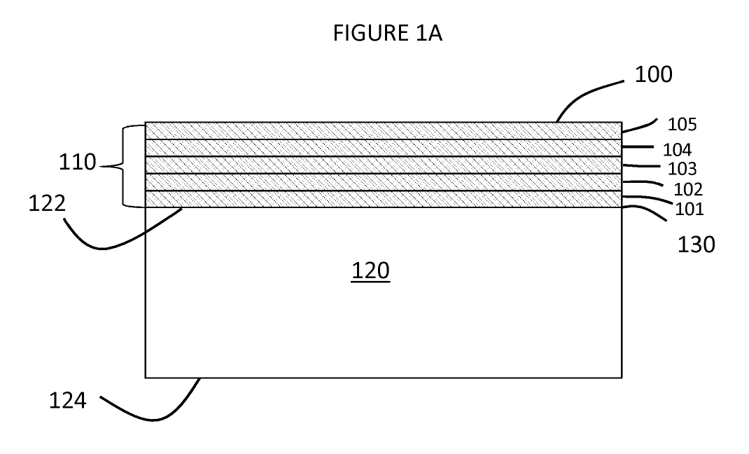

Referring to FIG. 1, the glass-film laminate 100 includes a strengthened glass substrate 120 as described herein, having opposing major surfaces 122, 124, and a film 110 disposed on at least one opposing major surface (122 or 124). In embodiments, the film 110 may be disposed on the minor surface(s) (not shown) of the strengthened glass substrate in addition to or instead of being disposed on at least one major surface (122 or 124).

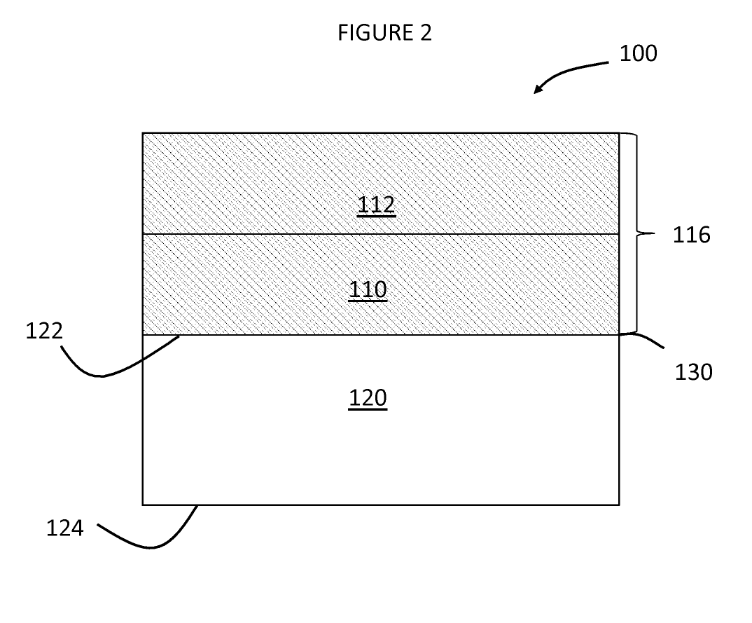

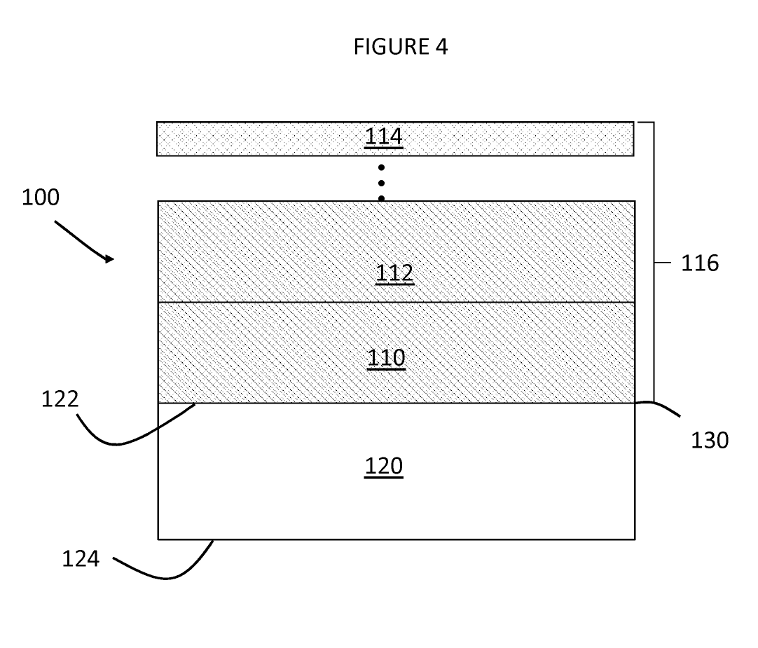

The term “film”, as applied to the film 110 or the additional film 112 (as shown in FIGS. 2-4) or other films 114 (as shown in FIG. 4), includes one or more layers that are formed by any known method in the art, including discrete deposition or continuous deposition processes. Such layers may be in direct contact with one another. The layers may be formed from the same material or more than one different material. In embodiments, such layers may have intervening layers of different materials disposed therebetween. In embodiments, a film may include one or more contiguous and uninterrupted layers, or one or more discontinuous and interrupted layers (i.e., a layer having different materials formed adjacent to one another).

As used herein, the term “dispose” includes coating, depositing, forming, or a combination thereof, a material onto a surface using any known method in the art. The disposed material may constitute a layer or film as defined herein. The phrase “disposed on” includes the instance of forming a material onto a surface such that the material is in direct contact with the surface, and includes the instance where the material is formed on a surface, where one or more intervening material(s) is between the disposed material and the surface. The intervening material(s) may constitute a layer or film, as defined herein.

In one variant, the glass-film laminate 100 may exhibit an asymmetric flexural strength. As used herein, an asymmetric flexural strength means the flexural strength of the glass-film laminate 100 differs depending on the direction from which the flexural load is being applied to the glass-film laminate. In another variant, the glass-film laminate 100 may exhibit an asymmetric impact resistance. As used herein, an asymmetric impact resistance means the impact resistance differs depending on the direction of impact (i.e., depends on which side of the glass-film laminate is impacted). In yet another variant, the glass-film laminate 100 may exhibit an asymmetric flexural strength and an asymmetric impact resistance. While other methods for creating glass-film laminates with a controlled failure strength level (such as sandblasting, scribing, laser damage, etc.) can introduce optical scattering (e.g., optical light scattering from surface roughness) or optical distortion (e.g., from refractive index variations), the glass-film laminates 100 descried herein may be optically transmissive and substantially free from optical distortion including any optical scattering, as will be described in greater detail below. In other words, the glass-film laminates 100 according to embodiments exhibit a controlled failure strength level or distribution while maintaining similar or improved optical properties as glass-film laminates without a controlled failure strength level or distribution.

Without being bound by theory, it is believed that the asymmetric impact resistance is at least partially dependent on the adhesion of the film 110 to the strengthened glass substrate 120 and on one or more of the elastic modulus of the film 110, the hardness of the film 110, and the brittle fracture behavior of the film 110. Brittle fracture behavior is typically associated with materials that exhibit minimal ductile or plastic deformation. Such materials may have relatively high glass transition temperatures in the case of amorphous or polymeric materials. Films that exhibit brittle fracture behavior have been found to enhance the asymmetric breakage behavior of the glass-film laminates 100. Brittle fracture behavior can also be associated with a relatively low strain-to-failure of the film 110, as will be described further below. Without being bound by theory, adhesion may be promoted through careful cleaning and preparation of the strengthened glass substrate 120 surface prior to combination with the film 110, the selection of film 110 materials, and selection of film-forming conditions.

In embodiments, the strengthened glass substrates 120 utilized in the glass-film laminates 100 described herein may include sheet articles and may exclude glass fibers because such fibers do not include opposing major surfaces 122, 124. As used herein, the strengthened glass substrate 120 may be substantially planar, although other embodiments may utilize a curved or otherwise shaped or sculpted glass substrate. In embodiments, the strengthened glass substrates 120 may include glass fibers. The strengthened glass substrate 120 may be substantially clear, generally transparent and free from light scattering. The strengthened glass substrate may have a refractive index from about 1.45 to about 1.55. The strengthened glass substrate 120 may be pristine and flaw-free before it is strengthened. Strengthened glass substrates 120 may be characterized as having a high average flexural strength (when compared to glass substrates that are not strengthened) or high surface strain-to-failure (when compared to glass substrates that are not strengthened) on one or more major opposing surfaces of such substrates. The glass-film laminates 100 may also have a relatively high average flexural strength or high surface strain-to-failure. For example, the strengthened glass substrate 120 may exhibit an average strain-to-failure that is 0.5% or greater, 0.6% or greater, 0.7% or greater, 0.8% or greater, 0.9% or greater, 1% or greater, 1.1% or greater, 1.2% or greater, 1.3% or greater, 1.4% or greater 1.5% or greater, or even 2% or greater, including all ranges and sub-ranges therebetween. In specific embodiments, the strengthened glass substrate 120 or the glass-film laminate 100 may exhibit an average strain-to-failure of 1.2%, 1.4%, 1.6%, 1.8%, 2.2%, 2.4%, 2.6%, 2.8%, or 3%. In embodiments, the strengthened glass substrate 120 exhibits an average strain-to-failure that is greater than the strain-to-failure of the film 110, the additional film 112 (as shown in FIGS. 2-4) and/or the other films 114 (as shown in FIG. 4). Alternatively or additionally, the strengthened glass substrate 120 or the glass-film laminate 100 may exhibit an average flexural strength that is greater than about 300 MPa, greater than 400 MPa, greater than 500 MPa, greater than 700 MPa, greater than 1000 MPa, greater than 1500 MPa, or greater than 2000 MPa, including all ranges and sub-ranges therebetween. These values of average strain-to-failure and/or average flexural strength may be exhibited by the glass-film laminate 100, which may also exhibit a high Weibull modulus (e.g., greater than 10) or a narrow failure strength distribution (e.g., less than about +/−20%) value, such as those values specified elsewhere herein.

Additionally or alternatively, the thickness of the strengthened glass substrate 120 may vary along one or more of its dimensions for aesthetic and/or functional reasons. For example, the edges of the strengthened glass substrate 120 may be thicker as compared to more central regions of the strengthened glass substrate. The length, width, and thickness dimensions of the strengthened glass substrate 120 may also vary according to the glass-film laminate 100 application or use.

The strengthened glass substrate 120 may be provided using a variety of different processes. For instance, example glass substrate forming methods include float glass processes and down-draw processes such as fusion draw and slot draw.

In the float glass process, a glass substrate that may be characterized by smooth surfaces and uniform thickness is made by floating molten glass on a bed of molten metal, typically tin. In an example process, molten glass that is fed onto the surface of the molten tin bed forms a floating glass ribbon. As the glass ribbon flows along the tin bath, the temperature is gradually decreased until the glass ribbon solidifies into a solid glass substrate that can be lifted from the tin onto rollers. Once off the bath, the glass substrate can be cooled further and annealed to reduce internal stress.

Down-draw processes produce glass substrates having a uniform thickness that possess relatively pristine surfaces. Because the average flexural strength of the glass substrate is controlled by the amount and size of surface flaws, a pristine surface that has had minimal contact has a higher initial strength. When this high strength glass substrate is then further strengthened (e.g., chemically), the resultant strength can be higher than that of a glass substrate with a surface that has been lapped and polished. Down-drawn glass substrates may be drawn to a thickness of less than about 2 mm. In addition, down drawn glass substrates have a very flat, smooth surface that can be used in its final application without costly grinding and polishing.

The fusion draw process, for example, uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank as two flowing glass films. These outside surfaces of the drawing tank extend down and inwardly so that they join at an edge below the drawing tank. The two flowing glass films join at this edge to fuse and form a single flowing glass substrate. The fusion draw method offers the advantage that, because the two glass films flowing over the channel fuse together, neither of the outside surfaces of the resulting glass substrate comes in contact with any part of the apparatus. Thus, the surface properties of the fusion drawn glass substrate are not affected by such contact.

The slot draw process is distinct from the fusion draw method. In slot draw processes, the molten raw material glass is provided to a drawing tank. The bottom of the drawing tank has an open slot with a nozzle that extends the length of the slot. The molten glass flows through the slot/nozzle and is drawn downward as a continuous substrate and into an annealing region.

Once formed, glass substrates may be strengthened to form strengthened glass substrates. As used herein, the term “strengthened glass substrate” may refer to a glass substrate that has been chemically strengthened, for example through ion-exchange of larger ions for smaller ions in the surface of the glass substrate. However, other strengthening methods known in the art, such as thermal tempering, may be utilized to form strengthened glass substrates. As will be described, strengthened glass substrates may include a glass substrate having a surface compressive stress in its surface that aids in the strength preservation of the glass substrate. The glass substrates formed from a fusion draw method can derive their strength from their pristine surface quality. A pristine surface quality can also be achieved through etching or polishing and subsequent protection of glass substrate surfaces, and other methods known in the art.

Where a strengthened glass substrate 120 is strengthened via an ion-exchange process, the glass substrate 120 is typically immersed in a molten salt bath for a predetermined period of time. The ions at or near the surface(s) of the glass substrate are exchanged for larger metal ions from the salt bath, while the glass substrate is immersed. In one embodiment, the temperature of the molten salt bath is in the range from about 370° C. to about 480° C. and the predetermined time period is about two to about twelve hours. The incorporation of the larger ions into the glass substrate strengthens the glass substrate by creating a compressive stress in a near surface region or in regions at and adjacent to the surface(s) of the glass substrate. A corresponding tensile stress results within a central region or regions at a distance from the surface(s) of the glass substrate to balance the compressive stress. Glass substrates utilizing this strengthening process may be described more specifically as chemically-strengthened glass substrates 120 or ion-exchanged glass substrates 120.

In one example, sodium ions in a glass substrate are replaced by potassium ions from the molten bath, such as a potassium nitrate salt bath, though other alkali metal ions having larger atomic radii, such as rubidium or cesium, can replace smaller alkali metal ions in the glass. According to particular embodiments, smaller alkali metal ions in the glass can be replaced by Ag⁺ ions. Similarly, other alkali metal salts such as, but not limited to, sulfates, phosphates, halides, and the like, may be used in the ion exchange process.

The replacement of smaller ions by larger ions at a temperature below that at which the glass network can relax produces a concentration profile of ions across the surface(s) of the strengthened glass substrate 120 that results in a stress profile. The larger volume of the incoming ion produces a compressive stress (CS) on the surface and tension (central tension, or CT) in the center of the strengthened glass substrate 120. The compressive stress is approximately related to the central tension by the following relationship:

$$CS = CT ( \frac{t - 2 DOL}{DOL} )$$

where t is the total thickness of the strengthened glass substrate 120 and compressive depth of layer (DOL) is the depth of exchange. Depth of exchange may be described as the depth within the strengthened glass substrate 120 (i.e., the distance from a surface of the glass substrate to a central region of the glass substrate), at which ion exchange facilitated by the ion exchange process takes place.

In one embodiment, a strengthened glass substrate 120 can have a surface compressive stress of 300 MPa or greater, e.g., 400 MPa or greater, 450 MPa or greater, 500 MPa or greater, 550 MPa or greater, 600 MPa or greater, 650 MPa or greater, 700 MPa or greater, 750 MPa or greater, or 800 MPa or greater. The strengthened glass substrate 120 may have a compressive depth of layer 15 μm or greater, 20 μm or greater (e.g., 25 μm, 30 μm, 35 μm, 40 μm, 45 μm, 50 μm or greater) and/or a central tension of 10 MPa or greater, 20 MPa or greater, 30 MPa or greater, 40 MPa or greater (e.g., 42 MPa, 45 MPa, or 50 MPa or greater) but less than 100 MPa (e.g., 95, 90, 85, 80, 75, 70, 65, 60, 55 MPa or less). In one or more specific embodiments, the strengthened glass substrate 120 has one or more of the following: a surface compressive stress greater than 400 MPa, a depth of compressive layer greater than 15 μm, and a central tension greater than 18 MPa.

Without being bound by theory, it is believed that strengthened glass substrates 120 with a surface compressive stress greater than 400 MPa and a compressive depth of layer greater than about 15 μm typically have greater strain-to-failure than non-strengthened glass substrates (i.e., glass substrates that have not been ion exchanged or otherwise strengthened) or some strengthened glass substrates that have large or uncontrolled flaw distributions or poor surface quality.

Example ion-exchangeable glasses that may be used in the strengthened glass substrate 120 can include alkali aluminosilicate glass compositions or alkali aluminoborosilicate glass compositions, though other glass compositions are contemplated. As used herein, “ion exchangeable” means that a glass substrate is capable of exchanging cations located at or near the surface of the glass substrate with cations of the same valence that are either larger or smaller in size. One example glass composition comprises SiO₂, B₂O₃ and Na₂O, where (SiO₂+B₂O₃)≧66 mol. %, and Na₂O≧9 mol. %. In an embodiment, the glass substrate 120 includes a glass composition with at least 6 wt. % aluminum oxide. In a further embodiment, a glass substrate 120 includes a glass composition with one or more alkaline earth oxides, such that a content of alkaline earth oxides is at least 5 wt. %. Suitable glass compositions, in some embodiments, further comprise at least one of K₂O, MgO, and CaO. In a particular embodiment, the glass compositions used in the glass substrate 120 can comprise 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example glass composition suitable for the strengthened glass substrate 120 comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm SP₂O₃; where 12 mol. %≦(Li₂O+Na₂O+K₂O)≦20 mol. % and 0 mol. %≦(MgO+CaO)≦10 mol. %.

A still further example glass composition suitable for the strengthened glass substrate 120 comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≦(Li₂O+Na₂O+K₂O)≦18 mol. % and 2 mol. %≦(MgO+CaO)≦7 mol. %.

In a particular embodiment, an alkali aluminosilicate glass composition suitable for the strengthened glass substrate 120 comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio

$$\frac{Al {O}_{3} + {B}_{2} {O}_{3}}{\sum modifiers} > 1 ,$$

where in the ratio the components are expressed in mol. % and the modifiers are alkali metal oxides. This glass composition, in particular embodiments, comprises, consists essentially of, or consists of: 58-72 mol. % SiO₂; 9-17 mol. % Al₂O₃; 2-12 mol. % B₂O₃; 8-16 mol. % Na₂O; and 0-4 mol. % K₂O, wherein the ratio

$$\frac{{Al }_{2} {O}_{3} + {B}_{2} {O}_{3}}{\sum modifiers} > 1.$$

In another embodiment, an alkali aluminosilicate glass composition suitable for the strengthened glass substrate 120 comprises, consists essentially of, or consists of: 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

In yet another embodiment, the strengthened glass substrate 120 may include an alkali aluminosilicate glass composition comprising, consisting essentially of, or consisting of: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; wherein 12 mol. %≦Li₂O+Na₂O+K₂O≦20 mol. % and 0 mol. %≦MgO+CaO≦10 mol. %.

In still another embodiment, the strengthened glass substrate 120 may include an alkali aluminosilicate glass composition comprising, consisting essentially of, or consisting of: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≦SiO₂+B₂O₃+CaO≦69 mol. %; Na₂O+K₂O+B₂O₃+MgO+CaO+SrO>10 mol. %; 5 mol. %≦MgO+CaO+SrO≦8 mol. %; (Na₂O+B₂O₃)—Al₂O₃≦2 mol. %; 2 mol. %≦Na₂O—Al₂O₃≦6 mol. %; and 4 mol. %≦(Na₂O+K₂O)—Al₂O₃≦10 mol. %.

In an alternative embodiment, the strengthened glass substrate 120 may comprise an alkali aluminosilicate glass composition comprising, consisting essentially of, or consisting of: 2 mol % or more of Al₂O₃ and/or ZrO₂, or 4 mol % or more of Al₂O₃ and/or ZrO₂.

In some embodiments, the glass compositions used in the strengthened glass substrate 120 may be batched with 0-2 mol. % of at least one fining agent selected from a group that includes Na₂SO₄, NaCl, NaF, NaBr, K₂SO₄, KCl, KF, KBr, and SnO₂.

The strengthened glass substrate 120 according to one or more embodiments can have a thickness ranging from about 100 μm to 5 mm. Exemplary strengthened glass substrate 120 thicknesses range from 100 μm to 500 μm, e.g., 100, 200, 300, 400, or 500 μm. Further example strengthened glass substrate 120 thicknesses range from 500 μm to 1000 μm, e.g., 500, 600, 700, 800, 900, or 1000 μm. The strengthened glass substrate 120 may have a thickness greater than 1 mm, e.g., about 2, 3, 4, or 5 mm. In one or more specific embodiments, the strengthened glass substrate 120 may have a thickness of 2 mm or less or less than 1 mm. The strengthened glass substrate 120 may be acid polished or otherwise treated to remove or reduce the effect of surface flaws.

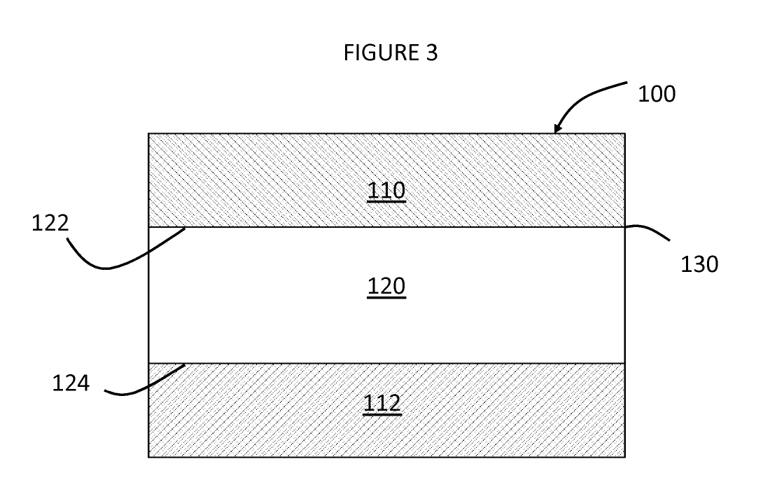

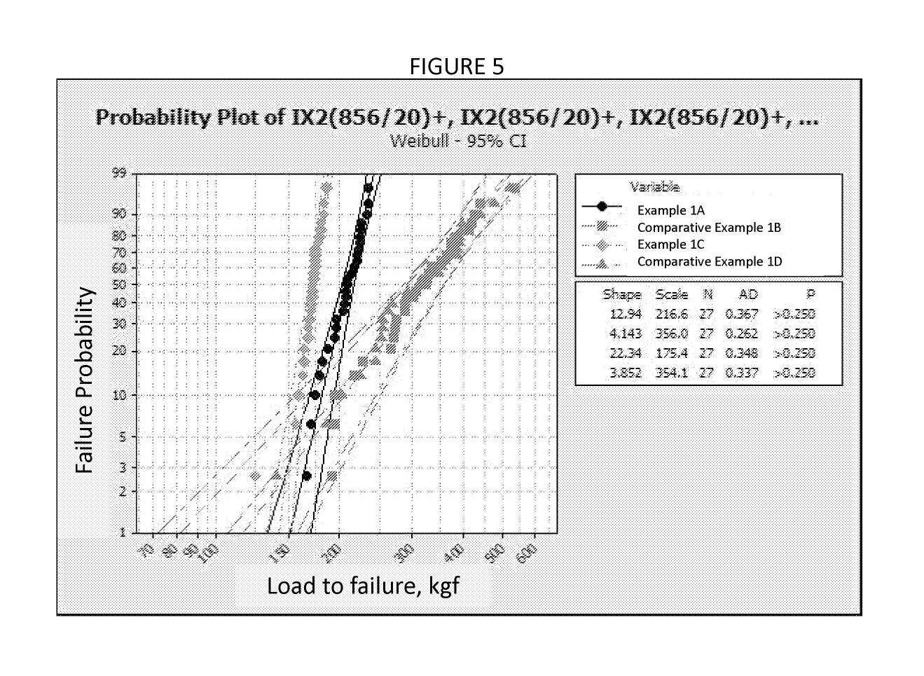

As shown in FIGS. 1, 1A and 2-4, a film 110 may be disposed on one of the major surfaces (122, 124) of the strengthened glass substrate 120. An additional film 112 and/or other films 114 may be disposed on the strengthened substrate, as shown in FIGS. 3 and 5. The arrangement of the film 110, additional film 112 and other films 114 in relation to one another and/or in relation to the strengthened glass substrate 120 may be varied according to application.

As shown in FIGS. 1, 1A and 2-4, the film 110 may form a first interface 130 with the glass substrate 120. In one or more embodiments, the film 110 may have an average film strain-to-failure that is less than the average strain-to-failure of the strengthened glass substrate 120. In a specific embodiment, during flexural loading, cracks tend to originate in the film 110 and, due to the strong adhesion between the film and the strengthened glass substrate 120, cracks originating in the film 110 can bridge, as defined herein, into the strengthened glass substrate 120 and can eventually lead to a catastrophic failure of the glass-film laminate 100. This distinct and engineered failure process mitigates the effects of preexisting flaw size populations on the strengthened glass substrate 120 surface, and leads to narrower strength distributions.

As used herein, the terms “bridge”, or “bridging”, refer to crack, flaw, or defect formation and such crack, flaw, or defect's growth in size and/or propagation from one material, layer or film into another material, layer or film. For example, bridging includes the instance where a crack that is present in the film 110 propagates into another material, layer, or film (e.g., the strengthened glass substrate 120). The terms “bridge” or “bridging” also include the instance where a crack crosses an interface between different materials, different layers, and/or different films. The materials, layers and/or films need not be in direct contact with one another for a crack to bridge between such materials, layers, and/or films. For example, the crack may bridge from a first material into a second material, not in direct contact with the first material, by bridging through an intermediate material disposed between the first and second material. The same scenario may apply to layers and films and combinations of materials, layers, and films. In the glass-film laminates described herein, a crack may originate in one of the film 110, the additional film 112, the other films 114, and/or the strengthened glass substrate 120, and bridge into the other(s) of the film 110, additional film 112, other films 114, and/or the strengthened glass substrate 120. The glass-film laminates 100 described herein exhibit a narrow distribution of failure strength such that crack bridging occurs in a more predictable and controlled manner.

The film 110 may be characterized as hard and/or brittle. In embodiments, the film 110 may exhibit a Young's modulus of about 10 GPa or greater. In specific embodiments, the film 110 may exhibit a Young's modulus of about 70 GPa or greater, 140 GPa or greater, or even 200 GPa or greater, including all ranges and sub-ranges therebetween. For example, the film 110 may exhibit a Young's modulus in the range from about 10 GPa to about 300 GPa, including all ranges and sub-ranges therebetween. In a one or more variants, the film 110 may exhibit a Young's modulus of about 10 GPa, about 11 GPa, about 12 GPa, about 13 GPa, about 14 GPa, about 15 GPa, about 16 GPa, about 17 GPa, about 18 GPa, about 19 GPa, about 20 GPa, about 25 GPa, about 30 GPa, about 35 GPa, about 40 GPa, about 45 GPa, about 50 GPa, about 55 GPa, about 60 GPa, about 65 GPa, about 75 GPa, about 80 GPa, about 85 GPa, about 90 GPa, about 95 GPa, about 100 GPa, about 105 GPa, about 110 GPa, about 115 GPa, about 120 GPa, about 125 GPa, about 130 GPa, about 135 GPa, about 145 GPa, about 150 GPa, about 155 GPa, about 160 GPa, about 165 GPa, about 170 GPa, about 175 GPa, about 180 GPa, about 185 GPa, about 190 GPa, about 195 GPa, about 205 GPa, about 210 GPa, about 215 GPa, about 220 GPa, about 225 GPa, about 230 GPa, about 235 GPa, about 240 GPa, about 245 GPa, about 250 GPa, about 255 GPa, about 260 GPa, about 265 GPa, about 270 GPa, about 275 GPa, about 280 GPa, about 285 GPa, about 290 GPa, about 295 GPa, about 300 GPa, or about 305 GPa.

In embodiments, the film 110 exhibits an average strain-to-failure that is less than the average strain-to-failure of the strengthened glass substrate 120. In accordance with one or more embodiments, the film 110 may exhibit an average strain-to-failure of 2% or less. In specific embodiments, the film 110 may exhibit an average strain-to-failure of 1.9% or less, 1.8% or less, 1.7% or less, 1.6% or less, 1.5% or less, 1.4% or less, 1.3% or less, 1.2% or less, 1.1% or less, 1.0% or less, 0.9% or less, 0.8% or less, 0.7% or less, 0.6% or less, or 0.5% or less, including all ranges and sub-ranges therebetween. In some cases, the film 110 may exhibit an average strain-to-failure greater than about 0.01%, or in some cases greater than 0.1%, to tolerate normal usage in applications.

The film 110 may include one or more layers. As shown in FIG. 1A, the film 110 may include a first layer 101, a second layer 102, a third layer 103, a fourth layer 104, and/or a fifth layer 105. It will be understood that FIG. 1A is merely illustrative and the number of layers of the film 110 may vary and the film may include a single layer, two layers, three layers, four layers, five layers, or more. The layers may include one or more of IR blocking (e.g., reflecting or absorbing) layers, UV blocking (e.g., reflecting or absorbing) layers, conducting layers, semiconducting layers, electronics layers, thin film transistor layers, touch-sensing layers, image-display layers, fluorescent layers, phosphorescent layers, light-emitting (such as organic light-emitting diode) layers, wavelength-selective reflecting layers, heads-up display layers, scratch-resistant layers, anti-reflection layers, anti-glare layers, dirt-resistant layers, self-cleaning layers, barrier layers, passivation layers, hermetic layers, diffusion-blocking layers and fingerprint resistant layers. The foregoing layers may include sub-layers of the same or different compositions from one another. Alternatively or additionally, the sub-layers may have different properties (e.g., mechanical, optical or electrical properties) from one another. The sub-layers may have the same or different thicknesses from one another.

In embodiments, the film 110 or the layers or sub-layers of the film may include oxides, oxynitrides, nitrides, carbides, siliceous polymers, semiconductors, transparent conductors, metals and combinations thereof. Exemplary oxides include SiO₂, Al₂O₃, TiO₂, Nb₂O₅, Ta₂O₅, ZrO₂, and combinations thereof. Similarly, oxynitrides or nitrides may include compounds of Si, Ti, Al, and the like with varying amounts of bonded oxygen and/or nitrogen. Exemplary carbides include compounds of Si, B, Ti, Zr, and the like. The siliceous polymers may be selected from the group consisting of siloxanes, silsesquioxanes, or combinations thereof. The semiconductors may be selected from the group consisting of Si, Ge, or combinations thereof. The transparent conductors may be selected from the group consisting of indium-tin-oxide, tin oxide, zinc oxide, or combinations thereof. In embodiments, a layer of even the entire film may have a uniform composition.

The film 110 may exhibit one or more functional properties. For example, such functional properties may include hardness, modulus, abrasion resistance, scratch resistance, mechanical durability, coefficient of friction, electrical conductivity, optical refractive index, density, opacity, transparency, reflectivity, and the like.

In embodiments, the film 110 as well as the glass-film laminate 100 may exhibit optical transparency and low optical distortion, including low optical scattering. In certain embodiments, such glass-film laminates 100 disclosed herein may be utilized in window applications. The glass-film laminate 100 may exhibit an optical transmittance over a portion of the visible wavelength range that is about 10% or greater, 20% or greater, 30% or greater, 40% or greater, 50% or greater, 60% or greater, 70% or greater, 80% or greater, or 90% or greater. For example, the glass-film laminate 100 may exhibit an optical transmittance in the range from about 10% to about 99%, from about 15% to about 99%, from about 20% to about 99%, from about 25% to about 99%, from about 30% to about 99%, from about 40% to about 99%, from about 50% to about 99%, from about 10% to about 90%, from about 10% to about 80%, from about 10% to about 70%, from about 10% to about 60%, from about 50% to about 90%, from about 60% to about 80%, from about 50% to about 70%, from about 70% to about 99%, from about 70% to about 90%, from about 80% to about 99%, from about 80% to about 90%, or from about 90% to about 99% including all ranges and sub-ranges therebetween.

The glass-film laminate 100 may exhibit an optical transmission haze (as measured by ASTM D1003 or similar methods) that is 10% or less, 5% or less, 4% or less, 3% or less, 2% or less, 1% or less, or even 0.5% or less. In embodiments, the glass-film laminate 100 may exhibit an optical transmission haze in the range from about 0.01% to about 10%, from about 1% to about 10%, from about 2% to about 10%, from about 3% to about 10%, from about 4% to about 10%, from about 5% to about 10%, from about 6% to about 10%, from about 7% to about 10%, from about 8% to about 10%, from about 9% to about 10%, from about 0.01% to about 5%, from about 0.1% to about 4%, from about 0.1% to about 3%, from about 0.1% to about 2%, or from about 0.1% to about 1%, including all ranges and sub-ranges therebetween. The glass-film laminate 100 exhibits such transmission haze regardless of the thickness of the glass-film laminate 100 (including the strengthened glass substrate utilized and/or any films disposed thereon).

Various thicknesses are contemplated for the film 110. For example, the film 110 may include a thickness of up to 100 μm. In embodiments, the film 110 may have a thickness in the range from about 0.002 to about 100 μm, from about 0.002 μm to about 90 μm, from about 0.002 μm to about 80 μm, from about 0.002 μm to about 70 μm, from about 0.002 μm to about 60 μm, from about 0.002 μm to about 50 μm, from about 1 μm to about 100 μm, from about 10 μm to about 100 μm, from about 20 μm to about 100 μm, from about 30 μm to about 100 μm, from about 40 μm to about 100 μm, from about 50 μm to about 100 μm, from about 0.002 μm to about 10 μm, from about 0.1 μm to about 10 μm, from about 1 μm to about 10 μm or from about 1.5 μm to about 10 μm, including all ranges and sub-ranges therebetween. In specific embodiments, the film 110 has a thickness of about 0.002 μm, about 0.0025 μm, about 0.003 μm, about 0.004 μm, about 0.005 μm, about 0.006 μm, about 0.007 μm, about 0.008 μm, about 0.009 μm, about 0.01 μm, about 0.015 μm, about 0.02 μm, about 0.025 μm, about 0.03 μm, about 0.035 μm, about 0.04 μm, about 0.045 μm, about 0.05 μm, about 0.055 μm, about 0.06 μm, about 0.065 μm, 0.07 μm, 0.075 μm, about 0.08 μm, about 0.085 μm, about 0.09 μm, about 0.095 μm, about 0.10 μm, about 0.15 μm, about 0.20 μm, about 0.25 μm, about 0.30 μm, about 0.35 μm, about 0.40 μm, about 0.45 μm, about 0.50 μm, about 0.55 μm, about 0.60 μm, about 0.65 μm, about 0.70 μm, about 0.75 μm, about 0.80 μm, about 0.85 μm, about 0.90 μm, about 0.95 μm, about 1.0 μm, about 1.1 μm, about 1.2 μm, about 1.3 μm, about 1.4 μm, about 1.5 μm, about 1.6 μm, about 1.7 μm, about 1.8 μm, about 1.9 μm, about 2 μm, about 2.5 μm, about 3 μm, about 3.5 μm, about 4 μm, about 4.5 μm, about 5 μm, about 5.5 μm, about 6 μm, about 6.5 μm, about 7 μm, about 7.5 μm, about 8 μm, about 8.5 μm, about 9 μm, about 9.5 μm or about 10 μm. In embodiments, the thickness of the film 110 may be minimized.

In accordance with one or more embodiments, the glass-film laminate 100 includes an interface 130 between the film and the strengthened glass substrate 120, at which the film is adhered to the strengthened glass substrate. In embodiments, the film 110 is adhered to the strengthened glass substrate such that there is no visible delamination of the film from the glass substrate, when observed under an optical microscope, after the glass-film laminate has been indented with a Berkovich diamond indenter using a non-zero load of up to about 40 grams (e.g., up to about 2 grams, up to about 4 grams, up to about 6 grams, up to about 8 grams, up to about 10 grams, up to about 12 grams, up to about 14 grams, up to about 16 grams, up to about 18 grams, up to about 20 grams, up to about 22 grams, up to about 24 grams, up to about 26 grams, up to about 28 grams, up to about 30 grams, up to about 32 grams, up to about 34 grams, up to about 36 grams, or up to about 38 grams, including all ranges and sub-ranges therebetween).

When the glass-film laminate 100 is subjected to a flexural load (e.g., during flexural strength testing), the film 110 may exhibit a total net stress during such loading that is sufficient to cause crack bridging between the film 110 and the strengthened glass substrate 120. The total net stress of the film 110 is sufficient to cause crack bridging across the interface 130 (e.g., cracks originating in the film 110 bridging into the strengthened glass substrate 120 or cracks originating in the strengthened glass substrate 120 bridging into the film 110). The total net stress of the film 110 may be sufficient to cause crack bridging between the film, the additional film 112 and/or the other films 114. As used herein, the term “net stress” includes the intrinsic stress in the film 110 (e.g., stress that is present or created in the film 110 during disposition or formation), stress due to coefficient of thermal expansion mismatch (e.g., between the film 110, the strengthened glass substrate 120, additional film 112 and/or other films 114), and tensile stress due to flexural loading. The net stress may include the sum of the foregoing stresses.

In embodiments, the film 110 exhibits a fracture toughness of about 10 MPa·m^{1/2} or less. For example, the film 110 may exhibit a fracture toughness in the range from about 0.1 MPa·m^{1/2} to about 10 MPa·m^{1/2}, including all ranges and sub-ranges therebetween. In specific embodiments, the fracture toughness of the film 110 is about 0.1 MPa·m^{1/2}, about 0.2 MPa·m^{1/2}, about 0.3 MPa·m^{1/2}, about 0.4 MPa·m^{1/2}, about 0.5 MPa·m^{1/2}, about 0.6 MPa·m^{1/2}, about 0.7 MPa·m^{1/2}, about 0.8 MPa·m^{1/2}, about 0.9 MPa·m^{1/2}, about 1 MPa·m^{1/2}, about 2 MPa·m^{1/2}, about 3 MPa·m^{1/2}, about 4 MPa·m^{1/2}, about 5 MPa·m^{1/2}, about 6 MPa·m^{1/2}, about 7 MPa·m^{1/2}, about 8 MPa·m^{1/2}, about 9 MPa·m^{1/2}, or 10 MPa·m^{1/2}. In embodiments, the fracture toughness of the film 110 is less than the fracture toughness of the strengthened glass substrate 120.

In accordance with one or more embodiments, the film 110 exhibits a critical strain energy release rate (G_{IC}=K_{IC}²/E) of less than about 1 kJ/m². For example, the critical strain energy release rate may be about 0.99 kJ/m², 0.95 kJ/m², 0.9 kJ/m², about 0.8 kJ/m², about 0.7 kJ/m², about 0.6 kJ/m², about 0.5 kJ/m², about 0.4 kJ/m², about 0.3 kJ/m², about 0.2 kJ/m², about 0.1 kJ/m², about 0.09 kJ/m², about 0.08 kJ/m², about 0.07 kJ/m², about 0.06 kJ/m², about 0.05 kJ/m², about 0.04 kJ/m², about 0.03 kJ/m², about 0.02 kJ/m², about 0.01 kJ/m², about 0.009 kJ/m², about 0.008 kJ/m², about 0.007 kJ/m², about 0.006 kJ/m², about 0.005 kJ/m², about 0.004 kJ/m², about 0.003 kJ/m², about 0.002 kJ/m², or about 0.001 kJ/m², including all ranges and sub-ranges therebetween.

The interface 130 between the film 110 and the strengthened glass substrate 120 may exhibit an interfacial fracture toughness that is greater than about 25% or even 50% of the fracture toughness of the strengthened glass substrate 120. In one or more specific embodiments, the interfacial fracture toughness is greater than about 55%, 60%, 65%, 70%, 80%, 90% or 100% of the glass substrate fracture toughness. In certain embodiments, the interfacial fracture toughness is at least 1.1 times, 1.2 times, 1.3 times, 1.4 times, 1.5 times, 1.6 times, 1.7 times, 1.8 times, 1.9 times, 2 times, 2.5 times, 3 times, 3.5 times, 4 times, 4.5 times, 5 times, 5.5 times, 6 times, 6.5 times, 7 times, 7.5 times, 8 times, 8.5 times, 9 times, 9.5 times, or even 10 times greater than the glass substrate fracture toughness. A relatively high interfacial fracture toughness is typically correlated with a relatively strong adhesion between the film 110 and the strengthened glass substrate 120. Adhesion can also be characterized by various other metrics, such as using diamond indentation methods described herein.

In embodiments, the additional film 112 (i.e., second or plurality if two or more) may be disposed on the film 110 (i.e, first) such that the film 110 is between the additional film 112 and the strengthened glass substrate 120, as shown in FIG. 2. Alternatively, an additional film 112 may be disposed between the film 110 and the strengthened glass substrate 120 (not shown). In the embodiment shown in FIG. 3, the additional film 112 may be disposed on the opposite major surface (122, 124) from the film 110, such that the strengthened glass substrate 120 is disposed between the film 110 and the additional film 112. Specifically, the film 110 may be disposed on one major surface 122 and the additional film 112 may be disposed on the other major surface 124. In such embodiments, the film 110 may be subjected to tension during flexural loading.

In embodiments, the glass-film laminate 100 may include multiple films disposed on one or both major surfaces (122, 124) of the strengthened glass substrate 120. Such embodiments may be referred to as glass-film laminates 100 that include a multi-film systems. As shown in FIG. 4, the glass-film laminate 100 may include a multi-film system including a film 110, an additional film 112 and other films 114. The other films 114 may be disposed on either of the major surfaces 122, 124 of the strengthened glass substrate 120. In one variant, the other films 114 may be disposed between the film 110 and the additional film 112. In another variant, the other films 114 may be disposed between the film 110 and the strengthened glass substrate 120 or may be disposed between the additional film 112 and the strengthened glass substrate 120.

The additional film 112 and/or other films 114 may have the same properties as the film 110 or may have different properties as the film 110. For example, the additional film 112 and/or the other films 114 may be characterized as brittle but may not have the same level of brittleness as the film 110. In such embodiments, the additional film 112 and/or the other films 114 allow cracks to bridge between the film 110, additional film 112, the other films 114 and/or the strengthened glass substrate 120.

The additional film 112 and/or the other films 114 may include one or more layers. The layers may include one or more IR reflecting layers, UV reflecting layers, conducting layers, semiconducting layers, electronics layers, thin film transistor layers, touch-sensing layers, image-display layers, fluorescent layers, phosphorescent layers, light-emitting (such as organic light-emitting diode) layers, wavelength-selective reflecting layers, heads-up display layers, scratch-resistant layers, anti-reflection layers, anti-glare layers, dirt-resistant layers, self-cleaning layers, barrier layers, passivation layers, hermetic layers, diffusion-blocking layers and fingerprint resistant layers. The foregoing layers of the additional film 112 and/or other films 114 may include sub-layers of the same or different compositions from one another. Alternatively or additionally, the sub-layers may have different properties (e.g., mechanical, optical or electrical properties) from one another. The sub-layers may have the same or different thicknesses.

In embodiments, the additional film 112 and/or other films 114 may include oxides, oxynitrides, nitrides, carbides, siliceous polymers, semiconductors, transparent conductors, metals and combinations thereof. Exemplary oxides include SiO₂, Al₂O₃, TiO₂, Nb₂O₅, Ta₂O₅, ZrO2, and combinations thereof. Similarly, oxynitrides or nitrides may include compounds of Si, Ti, Al, and the like with varying amounts of bonded oxygen and/or nitrogen. Exemplary carbides include compounds of Si, B, Ti, Zr and the like. The siliceous polymers may be selected from the group consisting of siloxanes, silsesquioxanes, or combinations thereof. The semiconductors may be selected from the group consisting of Si, Ge, or combinations thereof. The transparent conductors may be selected from the group consisting of indium-tin-oxide, tin oxide, zinc oxide, or combinations thereof.

The thickness of the additional film 112 and/or other films 114 may vary according to application. In embodiments, the thickness of the additional film 112 and/or other films 114 may be minimized. The additional film 112 and/or other films 114 may include a thickness of up to 100 μm, or a thickness in the range from about 0.002 μm to about 10 μm, including all ranges and sub-ranges therebetween. In specific embodiments, the additional film 112 and/or the other films 114 have a thickness of about 0.003 μm, about 0.004 μm, about 0.005 μm, about 0.006 μm, about 0.007 μm, about 0.008 μm, about 0.009 μm, about 0.01 μm, about 0.015 μm, about 0.02 μm, about 0.025 μm, about 0.03 μm, about 0.035 μm, about 0.04 μm, about 0.045 μm, about 0.05 μm, about 0.055 μm, about 0.06 μm, about 0.065 μm, about 0.07 μm, about 0.075 μm, about 0.08 μm, about 0.085 μm, about 0.09 μm, about 0.095 μm, about 0.10 μm, about 0.15 μm, about 0.20 μm, about 0.25 μm, about 0.30 μm, about 0.35 μm, about 0.40 μm, about 0.45 μm, about 0.50 μm, about 0.55 μm, about 0.60 μm, about 0.65 μm, about 0.70 μm, about 0.75 μm, about 0.80 μm, about 0.85 μm, about 0.90 μm, about 0.95 μm, about 1.0 μm, about 1.1 μm, about 1.2 μm, about 1.3 μm, about 1.4 μm, about 1.5 μm, about 1.6 μm, about 1.7 μm, about 1.8 μm, about 1.9 μm, about 2 μm, about 2.5 μm, about 3 μm, about 3.5 μm, about 4 μm, about 4.5 μm, about 5 μm, about 5.5 μm, about 6 μm, about 6.5 μm, about 7 μm, about 7.5 μm, about 8 μm, about 8.5 μm, about 9 μm, or about 9.5 μm, including all ranges and sub-ranges therebetween. The thicknesses of the additional film 112 and other films 114 may be the same or different from one another and/or from the film 110.

In embodiments, the film 110, additional film 112, and/or other films 114 form a stack 116, as shown in FIGS. 2 and 4, that exhibits a fracture toughness of about 10 MPa·m^{1/2} or less. In specific embodiments, the stack 116 may exhibit a fracture toughness in the range from about 0.1 MPa·m^{1/2} to about 10 MPa·m^{1/2}, including all ranges and sub-ranges therebetween. In one or more variants, the stack 116 may exhibit a fracture toughness of about 0.05 MPa·m^{1/2}, about 0.1 MPa·m^{1/2}, about 0.2 MPa·m^{1/2}, about 0.3 MPa·m^{1/2}, about 0.4 MPa·m^{1/2}, about 0.5 MPa·m^{1/2}, about 0.6 MPa·m^{1/2}, about 0.7 MPa·m^{1/2}, about 0.8 MPa·m^{1/2}, about 0.9 MPa·m^{1/2}, about 1 MPa·m^{1/2}, about 2 MPa·m^{1/2}, about 3 MPa·m^{1/2}, about 4 MPa·m^{1/2}, about 5 MPa·m^{1/2}, about 6 MPa·m^{1/2}, about 7 MPa·m^{1/2}, about 8 MPa·m^{1/2}, about 9 MPa·m^{1/2}, or 10 MPa·m^{1/2}. In embodiments, the fracture toughness of the stack 116 is less than the fracture toughness of the strengthened glass substrate.

The film 110, the additional film 112, and/or the other films 114 may be disposed by a vacuum deposition technique, for example, chemical vapor deposition (e.g., plasma enhanced chemical vapor deposition), physical vapor deposition (e.g., reactive or nonreactive sputtering or laser ablation), thermal or e-beam evaporation, or atomic layer deposition. The film 110, additional film 112, and/or other films 114, may also be disposed on one or more surfaces 122, 124 of the strengthened glass substrate 120 using liquid-based techniques, for example sol-gel coating or polymer coating methods, for example spin, spray, slot draw, slide, wire-wound rod, blade/knife, air knife, curtain, gravure, and roller coating among others. In some embodiments it may be desirable to use adhesion promoters between the film 110 and the strengthened glass substrate 120, between the strengthened glass substrate 120 and additional film 112, between the film 110, additional film 112, and/or other films 114, between the film 110 between the layers (if any) of the film 110, between the layers (if any) of the additional film 112 and/or between the layers (if any) of the other films 114. In alternative embodiments, the film 110, the additional film 112, and/or other films 114, may be disposed as a transfer layer.

In embodiments in which the glass-film laminate includes a multi-film system, the film 110, the additional film 112, and/or the other films 114, may be adhered to one another and to the strengthened glass substrate 120 such that there is no visible delamination of the film 110, additional film 112, or other films 114, from the strengthened glass substrate 120 or one another, when observed under an optical microscope, after the glass-film laminate has been indented with a Berkovich diamond indenter using a non-zero load of up to about 40 grams (e.g., up to about 2 grams, up to about 4 grams, up to about 6 grams, up to about 8 grams, up to about 10 grams, up to about 12 grams, up to about 14 grams, up to about 16 grams, up to about 18 grams, up to about 20 grams, up to about 22 grams, up to about 24 grams, up to about 26 grams, up to about 28 grams, up to about 30 grams, up to about 32 grams, up to about 34 grams, up to about 36 grams, or up to about 38 grams, including all ranges and sub-ranges therebetween). In embodiments, the indentation may be applied against either side of the glass-film laminate 100 as long as at least the film 110 is present on the side on which the indentation is applied (i.e., the film 110 is subjected to the indentation).

In embodiments in which the glass-film laminate includes a multi-film system, the film 110 and one or both of the additional film 112 or other films 114, form interfaces between one another and/or with the strengthened glass substrate 120 and at least one of such interfaces exhibits a fracture toughness that is greater than 25% or even 50% of the fracture toughness of the strengthened glass substrate 120. In embodiments, all of such interfaces in the multi-film system exhibit a fracture toughness that is greater than about 50% of the fracture toughness of the strengthened glass substrate 120. For example, the fracture toughness of the interfaces may be greater than 55%, 60%, 65%, 70%, 75%, 80%, 85%, 90%, 95%, or even 100% than the fracture toughness of the strengthened glass substrate 120. In certain embodiments, the fracture toughness of at least one of the interfaces is at least 1.1 times, 1.2 times, 1.3 times, 1.4 times, 1.5 times, 1.6 times, 1.7 times, 1.8 times, 1.9 times, 2 times, 2.5 times, 3 times, 3.5 times, 4 times, 4.5 times, 5 times, 5.5 times, 6 times, 6.5 times, 7 times, 7.5 times, 8 times, 8.5 times, 9 times, 9.5 times, or even 10 times greater than the glass substrate fracture toughness.

A second aspect of this disclosure pertains to specific applications incorporating the glass-film laminates 100 disclosed herein. In one or more embodiments, an automotive window includes a glass-film laminate 100. When used in automotive window applications, the glass-film laminate 100 may exhibit an optical transmission over a portion of the visible wavelength range that is about 10% or greater, 20% or greater, 30% or greater, 40% or greater, 50% or greater, 60% or greater, 70% or greater, 80% or greater, or 90% or greater, including all ranges and sub-ranges therebetween. The glass-film laminate 100 may also exhibit low optical scattering, which can be characterized as an optical transmission haze (as measured by ASTM D1003 or similar methods) that is, 10% or less, 5% or less, 4% or less, 3% or less, 2% or less, 1% or less, or even 0.5% or less, including all ranges and sub-ranges therebetween. The glass-film laminate 100 exhibits such transmission haze regardless of the thickness of the glass-film laminate 100 (including the strengthened glass substrate utilized and/or any films disposed thereon).

The automotive window application can additionally benefit from added functionality of the film 110, film 112, or other films 114, such as some of the functions mentioned herein, including UV blocking, IR blocking, touch sensing, information display, or wavelength-selective reflection for heads-up displays. The glass-film laminate 100, when used in automotive window applications may exhibit both a narrow and controlled failure strength distribution as well as an asymmetric flexural strength or an asymmetric impact resistance, such that the glass-film laminate withstands greater external impact forces, but breaks under relatively lower internal impact forces, enhancing passenger safety.

The embodiments of the glass-film laminates 100 disclosed herein exhibit a narrow failure strength distribution by recognizing the relationship between the properties of strengthened glass substrates 120 and the films 110 thereon. In embodiments, the strengthened glass substrates 120 utilized have a specific flaw distribution as a result of the ion exchange process, handling, cleaning, and/or other factors. All of these factors may contribute to the strain-to-failure of a glass substrate, including the disclosed strengthened glass substrates 120. Glass substrates with large or uncontrolled flaw distributions or poor surface quality, even if strengthened, may still exhibit relatively low strain-to-failure, as compared to the strengthened glass substrates 120 described herein, which exhibit relatively high strain-to-failure. In some embodiments, the film 110 exhibits well-defined properties that are specifically tailored to the disclosed strengthened glass substrates 120. For example, the strain-to-failure or toughness of the film 110 is defined with respect to the flaw distributions in a given strengthened glass substrate, resulting in a condition where the strain-to-failure of the glass substrate is higher than the strain-to-failure of one or more of the films.

In embodiments, the glass-film laminate may include a glass substrate (which may be strengthened) having an average substrate strain-to-failure, measured at one or both of the first major surface and the second major surface, that is greater than the average film strain-to-failure and the laminate has a failure strength distribution, as measured on 10 or more substantially identical laminates, that varies by less than about +/−20% (e.g., or less than +/−10%, or less than +/−5%) above and below the average strength of the 10 or more laminates.

A third aspect of this disclosure pertains to a method of forming the glass-film laminates. In embodiments, the method includes providing a strengthened glass substrate 120 and disposing a film 110 on a surface of the strengthened glass substrate. The film may exhibit an average strain-to-failure that is greater than the average strain-to-failure of the strengthened glass substrate. The method may include forming an interface between the film and the strengthened glass substrate that exhibits a fracture toughness as otherwise described herein (e.g., greater than about 25% or even 50% of the fracture toughness of the strengthened glass substrate). In specific embodiments, the method includes cleaning the surface of the strengthened glass substrate onto which the film is disposed before disposing the film on such surface. The surface may be cleaned by wet-cleaning or plasma cleaning. Wet-cleaning may include cleaning by the use of a liquid cleaning solution. Example liquid cleaning solutions may include KOH solutions, NaOH solutions, detergent solutions, acidic solutions, hydroxide solutions, and various solutions, and combinations of solutions known in the art such as “Piranha” and “RCA clean” recipes. Plasma cleaning may include exposing the strengthened glass substrate to a plasma created from one or more gaseous species (e.g., argon, oxygen, air, etc.). In embodiments, the method includes disposing an additional film 112 or other films 114 on the strengthened glass substrate 120 as described herein. The additional film 112 and/or the other films 114 may be disposed between the strengthened glass substrate 120 and the film 110. Alternatively, the additional film 112 and/or other films 114 may be disposed on an opposite major surface of the strengthened glass substrate 120 from the film 110.

In embodiments, the method includes controlling one or more properties of the film 110 to tune the failure strength of the glass-film laminate 100. As used herein, the term “control” may include the selection, variation or maintenance of one or more properties. Such film properties may include the film thickness, film modulus or film residual stress. One or more of the thickness, modulus or residual stress of the film may be controlled while the other(s) of the thickness, modulus or residual stress of the film may be fixed. For example, the Young's modulus and the residual stress of the film may be fixed, while the thickness of the film is controlled. In another example, the thickness and residual stress of the film are fixed, while the Young's modulus is controlled. In yet another example, the thickness and the Young's modulus of the film are fixed, while the residual stress of the film is controlled. Optionally, the thickness and the Young's modulus are controlled, while the residual stress is fixed. In another option, the Young's modulus and residual stress are controlled, while the thickness is fixed. In yet another option, the thickness and the residual stress are controlled, while the Young's modulus is fixed. Alternatively or additionally, all three of the film thickness, film modulus or film residual stress may be controlled simultaneously.

In one variant, the method includes controlling the film 110 thickness by depositing a controlled amount of film to provide a specific film thickness to tune the failure strength of the glass-film laminate. The film thickness may be controlled to either increase or decrease the film thickness. In embodiments, increasing the thickness reduces the failure strength of the glass-film laminate 100.

In another variant, the method includes controlling the film 110 modulus by selecting a film having a specific Young's modulus such that the glass-film laminate has a desired failure strength. In embodiments, the selection of a film with a greater Young's modulus results in a glass-film laminate with a lower failure strength.

In yet another variant, the residual stress of the film 110 may be controlled by depositing the film 110 in a manner to increase or decrease the residual stress of the film, to provide a glass-film laminate having a desired failure strength. Residual stress may be characterized as the initial stress in the film 110 formed during deposition or formation of the film and may include tensile stress or compressive stress. In one variant, the residual tensile stress can be increased in the film 110 so that the film 110 has a lower strain-to-failure or, in other words, a crack may form in the film 110 when the glass-film laminate 100 is subjected to a lower strain level. Moreover, without being bound by theory, a film 110 having a lower strain-to-failure increases the probability that a crack will form in the film 110 at a given load and thus tends to provide a narrow failure strength distribution. The residual tensile stress may be increased or decreased in the film 110 by modifying the deposition or formation of the film 110 using known methods in the art.

When controlling the properties of the film 110, one or more of the other properties of the film 110 may be held fixed to achieve the desired effect of controlled failure strength. Such other properties of the film, which may be held fixed, could include fracture toughness, density, microstructure, crystallinity, chemical composition, defect levels, roughness, particulate contamination, yield stress, plasticity, gaps or pinholes in the film, and other film properties mentioned herein or known in the art.

The failure strength or desired failure strength of the glass-film laminate 100 may be estimated using known methods in the art. For example, the failure strength may be estimated using variables or constants such as Young's modulus, Poisson's ratio, thickness and residual stress of the film, the critical energy release rate of the strengthened glass substrate (G_{Ic}), known geometry factors, and/or the compression stress in the strengthened glass substrate. Other factors that may be considered in estimating a failure strength of the glass-film laminate 100 include an assumed length of cracks that may be formed in the strengthened glass substrate surface. In addition, the failure strength of the glass-film laminate 100 may be determined experimentally using methods otherwise described herein, such as ring-on-ring testing or ball drop testing.

These above methods used to estimate or measure the failure strength or failure strength distribution of the glass-film laminate may also be used to estimate or measure the failure strength and failure strength distribution of strengthened glass substrates 120 used in the laminates. In embodiments, the failure strength of the strengthened glass substrate 120 may be measured using a ring-on-ring bending test, which measures the bending stress, σ, at an outer surface of the strengthened glass substrate 120.

Without being bound by theory, it is believed that a cracked film has associated energy that can be utilized to control the fracture of an underlying glass substrate (including an underlying strengthened glass substrate). The magnitude of the energy, in the form of energy release rate, depends on the mechanical properties of the film and underlying glass substrate materials. For example, the energy release rate can be a function of the ratio of the film Young's modulus over the glass substrate Young's modulus. The energy release rate may also be proportional to the thickness of the film. Furthermore, a higher tensile residual stress may also influence the energy to the fracture of the glass substrate.

In embodiments, where a strengthened glass substrate 120 has a known failure strength and/or failure strength distribution, the Young's modulus of the film 110 may be fixed and the thickness of the film 110 may be controlled, as described herein, to provide a glass-film laminate having a desired failure strength or failure strength distribution.

Additionally or alternatively, where a strengthened glass substrate 120 has a known failure strength or failure strength distribution, the thickness of the film 110 may be fixed and the Young's modulus of film 110 may be controlled, as described herein, to provide a glass-film laminate having a desired failure strength or failure strength distribution.

The method may include using a known failure strength or failure strength distribution of a strengthened glass substrate 120 and controlling the residual stress of the film 110, as described herein, to provide a glass-film laminate 100 having a desired failure strength or failure strength distribution.

Alternatively or additionally, the method may include controlling other properties of the film 110, such as the strain-to-failure or toughness, to provide a glass-film laminate with a desired failure strength or failure strength distribution. The method may include controlling the strain-to-failure or toughness of the film 110 instead of or in addition to controlling one or more of the film modulus, film thickness or film residual stress.

Alternatively or additionally, the method may include controlling one or more other properties of the film 110 (such as density, microstructure, crystallinity, chemical composition, defect levels, roughness, particulate contamination, yield stress, plasticity, gaps or pinholes in the film, and other film properties mentioned herein or known in the art) to control the strain-to-failure of the film 110. Control of the strain-to-failure of the film 110 may enable control of the failure strength of the glass-film laminate 100.

Referring to FIG. 1A, the film 110 may include one or more layers, as described herein. In such embodiments, where the strengthened glass substrate 120 has a known strength distribution, the thickness, Young's modulus, residual stress, strain-to-failure and/or toughness of one or more of the layers 101, 102, 103, 104, and 105, may be controlled to provide a glass-film laminate having the controlled failure strength or failure strength distribution.

In embodiments disclosed herein in which one or more film 110 properties are fixed, it will be understood that such properties may alternatively or additionally be permitted to change according to normal process variability (e.g., changing the thickness can cause the residual film to change). The properties of the additional film 112, and other films 114 may also be controlled as described herein with respect to the film 110.

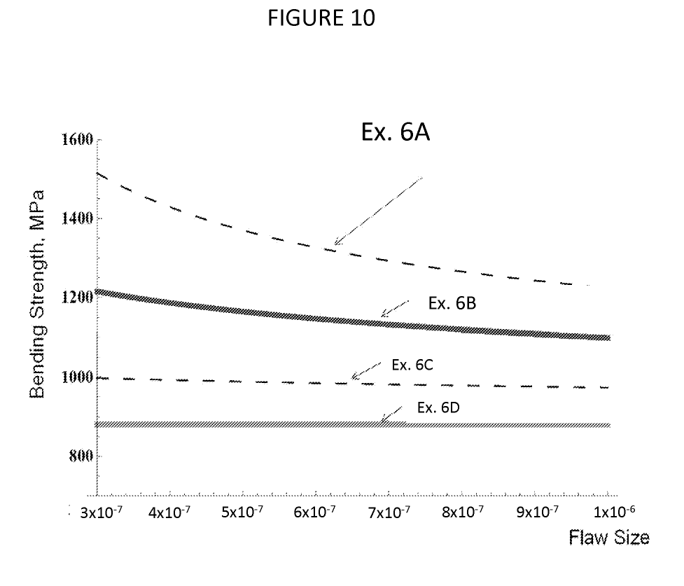

FIG. 10 illustrates one or more embodiments of the method disclosed herein. The horizontal axis of the graph shown in FIG. 10 represents the flaw size in the strengthened glass substrate 120 in meters. The dashed line illustrates the ring-on-ring strength results for a strengthened glass substrate 120 without any film disposed thereon (Example 6A). The remaining solid lines illustrate estimates of the failure strength of the glass-film laminates according to one or more embodiments disclosed herein. Such estimates were evaluated using methods known in the art. The glass-film laminates include an ITO film 110 having different thicknesses, as indicated in FIG. 10. Example 6B includes a 30 nm ITO film 110, Example 6C includes a 60 nm ITO film 130, and Example 6D includes an 85 nm ITO film 110. Without being bound by theory, this estimation shows that as the thickness of the film 110 increases, any pre-existing flaws of the strengthened glass substrate 120 are less influential in the failure strength distribution of the glass-film laminates 100 that include such strengthened glass substrate 120, thus this leads to lower failure strength variability, i.e., higher Weibull Modulus. This relationship is illustrated in FIG. 10.

Moreover, as also shown in FIG. 10, as the ITO film 110 thickness increases from 30 nanometers to 60 nanometers, and to 85 nanometers, the strength of the glass-film laminate 110 decreases. Therefore, the embodiments of the methods described herein allow the desired level of strength to be achieved by choosing the thickness of the film 110. It should also be noted that the strength curves in FIG. 10 as functions of flaws size of glass-film laminate 100 are virtually horizontal lines. This implies that the strength of glass-film laminate 100 is relatively insensitive to the flaw size. The strength of these glass-film laminates 100 have a narrower strength distribution as compared to a strengthened glass substrate 120 without a film disposed thereon, which is also shown in FIG. 10. Without being bound by theory, the estimation method illustrated by FIG. 10 is consistent with the experimental results disclosed herein, which demonstrate that thicker films 110 can be utilized to lower the failure strength of the glass-film laminate 100, and the presence of such films is experimentally demonstrated to create a narrower strength distribution (higher Weibull modulus) for the glass-film laminates.

### EXAMPLES

Various embodiments will be further described in by the following examples.

### Examples 1A-1D

Examples 1A-1D included glass-film laminates according to one or more embodiments of the present disclosure or strengthened glass substrates without a film disposed thereon. Each of Examples 1A-1D utilized commercially available glass substrates including aluminosilicate glass (Corning® 2319). The glass substrates had a thickness of 0.7 mm and were strengthened by an ion exchange process to provide a surface compressive strength of 856 MPa and a compressive depth of layer of about 20 μm. During the ion exchange process, the glass substrates were immersed in a molten potassium nitrate (KNO₃) bath that was heated to a temperature in the range from about 350° C. to about 450° C. for a about 3-8 hours.

After completing the ion exchange process, the strengthened glass substrates of Examples 1A-1D were wet cleaned in a 1-4% concentration KOH detergent solution, supplied by Semiclean KG, having a temperature of 50-70° C. During the cleaning process, the detergent solution was ultrasonically agitated at 40-110 KHz. The resulting strengthened glass substrates were then rinsed in DI water, which was also ultrasonically agitated at 40-110 KHz and thereafter dried.

The strengthened glass substrates of Examples 1A-1D were plasma cleaned using a chamber supplied by KDF, under the model name 903i. Plasma cleaning was performed at a pressure of about 15 mTorr and an oxygen flow of about 5 sccm and Ar flow rate of about 50 sccm using about 400 W RF power for a duration of about 1 minute.

After plasma cleaning was completed, the ITO film was disposed on a surface of the strengthened glass substrates of Examples 1A and 1C via DC magnetron sputtering. An ITO film was sputtered from an oxide target, using a system supplied by KDF, under the name model 903i. The sputtering target was also supplied by KDF and included SnO₂ and In₂O₃ present at a ratio of 10:90 by weight. The ITO film was sputtered at a pressure of 10 mTorr in the presence of oxygen flowed at a rate of about 0.2 sccm to about 0.5 sccm and argon flowed at a rate of 30 sccm, with DC power supplied at 600 W. After the ITO film was disposed, Examples 1A and 1C were annealed at a temperature of about 200° C. for 60 minutes in air. Comparative Examples 1B and 1D were also annealed under identical conditions, but were not combined with a film, as mentioned above. The ITO film of Example 1A had a thickness of about 30 nm and the ITO film of Example 1C had a thickness of about 85 nm. Each of Examples 1A-1D had a size of 2 inches by 2 inches.

Each of Examples 1A-1D were subjected to ring-on-ring testing to evaluate the flexural strength of the glass-film laminates of Examples 1A and 1C and the strengthened glass substrates of Comparative Examples 1B and 1D. This test method covers the determination of the biaxial strength of Examples 1A-1D at ambient temperature via concentric ring configurations under monotonic uniaxial loading. The ring-on-ring test was performed using a support ring having a diameter or about 1 inch and a loading ring having a diameter of about 0.5 inches. The contact radius of the loading ring was about 1.6 mm, and the head speed was 1.2 mm/min. The ring-on-ring test was generally performed according to the ASTM C-1499-03 standard test method for Monotonic Equibiaxial Flexural Strength of Advanced Ceramics at Ambient Temperatures, with a few modifications to test fixtures and test conditions as outlined in U.S. Patent Publication No. 2013/0045375, at [0027], incorporated by reference herein. Note that Examples 1A-1D were not abraded prior to ROR testing. For Examples 1A and 1C, the side of the glass-film laminates that included the ITO film disposed thereon was subjected to tension during the ring-on-ring testing. The results of the ring-on-ring testing are provided in the Weibull plot shown in FIG. 5.

As shown in FIG. 5, the Weibull moduli of Examples 1A and 1C were greater than about 12 or greater than about 20, respectively. In comparison, the Weibull moduli of Comparative Examples 1B and 1D were less than 5 or less than 4, respectively. FIG. 5 also illustrates that the failure strength of the glass-film laminates may be tuned by varying the thickness of the film disposed on the strengthened glass substrate. Disposing a thicker film on the strengthened glass substrate provided a glass-film laminate that exhibited lower failure strength than a glass-film laminate that included a thinner film. The glass-film laminates of Examples 1A and 1C both exhibited an optical transmission of greater than about 70% over a portion of the visible wavelength spectrum, and an optical transmission haze of less than about 2%.

Moreover, the glass-film laminates of Examples 1A and 1C also exhibited a characteristic failure strength of 216.6 kgf and 175.4 kgf, respectively, as indicated by the “scale” parameter of FIG. 5. In comparison, Examples 1B and 1D exhibited a characteristic failure strength of 356.0 kgf and 354.1 kgf, respectively.

The data demonstrates that the addition of brittle films to a strengthened glass substrate reduces the strength (i.e., load-to-failure). This reduction in strength increases as the thickness of the film increases. However, the combination of the film with a strengthened glass substrate provides a reduction in strength variability (i.e., higher Weibull modulus).

### Examples 2A-2D

Examples 2A-2D included glass-film laminates according to embodiments of the present disclosure or strengthened glass substrates without a film disposed thereon. Each of Examples 2A-2D utilized commercially available glass substrates including aluminosilicate glass (Corning® 2318). The glass substrates had a thickness of 0.7 mm and were strengthened and wet cleaned in the same manner as Examples 1A-1D; however the resulting strengthened glass substrates for Examples 2A-2D exhibited a surface compressive stress of about 684 MPa and a compressive depth of layer of about 23 μm. In addition, the strengthened glass substrates of Examples 2A-2D were not plasma cleaned.

After wet cleaning was completed, a chromium film was disposed on a surface of the strengthened glass substrates of Examples 2B, 2C and 2D via electron beam evaporation at room temperature and a base pressure of about 5×10⁻⁶ Torr, before deposition of the chromium film. The strengthened glass substrate of Comparative Example 2A was not combined with a film. The film of Example 2B had a thickness of about 300 nm, the film of Example 2C had a thickness of about 950 nm and the film of Example 2D had a thickness of about 3000 nm. Each of Examples 2A-2D had a size of 2 inches by 2 inches.

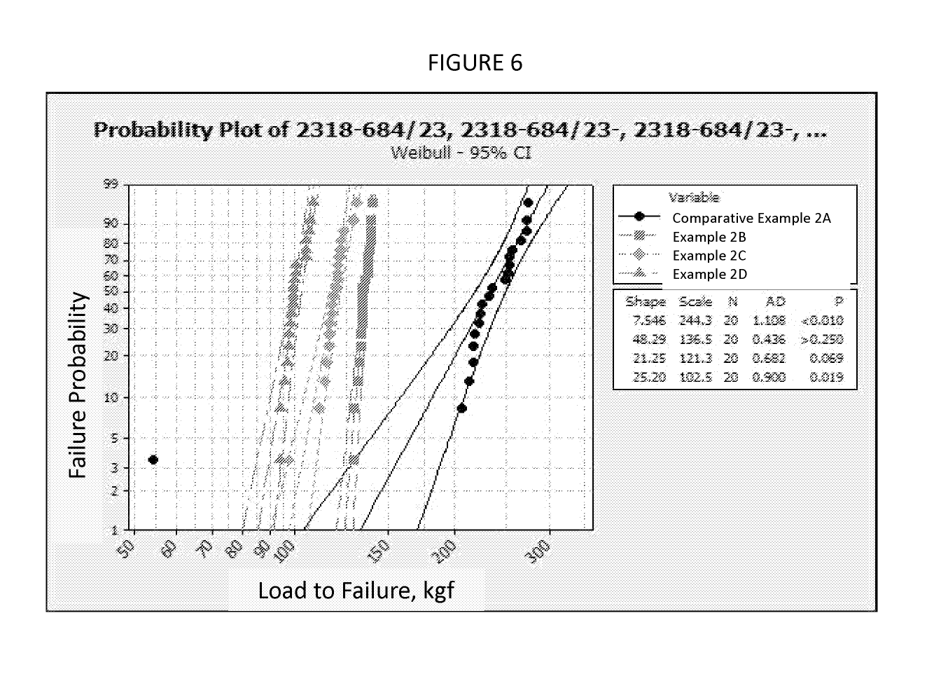

Each of Examples 2A-2D was subjected to ring-on-ring testing in the same manner as Examples 1A-1D. The results of the ring-on-ring testing are provided in the Weibull plot shown in FIG. 6.

As shown in FIG. 6, the Weibull moduli of Examples 2B, 2C and 2D were greater than about 48, greater than about 21, and greater than about 25, respectively. In comparison, the Weibull modulus of Comparative Example 2A was less than 8. FIG. 6 also illustrates that the failure strength of the glass-film laminates may be tuned by varying the thickness of the film disposed on the strengthened glass substrate. Disposing a thicker film on the strengthened glass substrate provided a glass-film laminate with a lower failure strength than a glass-film laminate incorporating a thinner film.

Moreover, the glass-film laminates of Examples 2B, 2C and 2D also exhibited a characteristic failure strength of 136.5 kgf, 121.3 kgf, and 102.5 kgf, respectively, as indicated by the “scale” parameter of FIG. 6. Comparative Example 2A exhibited a characteristic failure strength of 244.3 kgf.

The data shown in FIG. 6 illustrates similar trends as FIG. 5. Accordingly, the trends shown in FIG. 5 are also seen where a different film is utilized.

### Examples 3A AND 3B

Comparative Example 3A included a known strengthened glass substrate without a film disposed thereon and Example 3B included a glass-film laminate according to one or more embodiments of the present disclosure. Comparative Example 3A and Example 3B utilized commercially available glass substrates including aluminosilicate glass (Corning® 2319). The glass substrates had a thickness of 0.7 mm and were strengthened and wet cleaned in the same manner as Examples 1A-1D; however the resulting strengthened glass substrates had a surface compressive stress of about 983 MPa and a compressive depth of layer of about 20 μm. A chromium film was disposed on the strengthened glass substrate of Example 3B in the same manner as Examples 2B-2D; however the resulting chromium film had at thickness of 10 nm. Comparative Example 3A and Example 3B were not plasma cleaned.

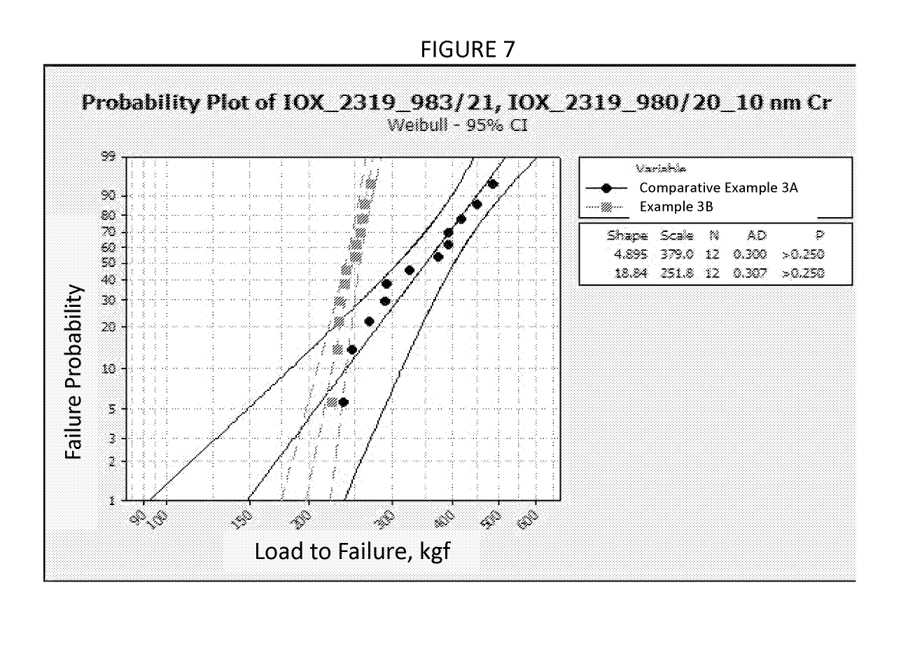

As shown in FIG. 7, the Weibull modulus of Example 3B was greater than 18, while the Weibull modulus of Comparative Example 3A was less than 5. FIG. 7 illustrates that in some cases even a very thin film (e.g., 10 nm) can increase the Weibull modulus to greater than about 15.

Moreover, the glass-film laminate of Example 3B also exhibited a characteristic failure strength of 251.8 kgf as indicated by the “scale” parameter of FIG. 7. Comparative Example 3A exhibited a characteristic failure strength of 379.0 kgf.

### Examples 4A-4D

Comparative Examples 4A-4B included strengthened glass substrates without a film and Examples 4C-4D included glass-film laminates according to embodiments of the present disclosure. Each of Examples 4A-4D utilized commercially available glass substrates including aluminosilicate glass (Corning® 2318). The glass substrates had a thickness of 0.7 mm and were strengthened and wet cleaned as in Examples 1A-1D; however the resulting strengthened glass substrates had a surface compressive stress of about 740 MPa and a compressive depth of layer of about 44 μm. The strengthened glass substrates of Examples 4A-4D were not plasma cleaned.

The strengthened glass substrate of Comparative Example 4A was not combined with a film or further treated before testing, as will be described below. The strengthened glass substrate of Comparative Example 4B was not combined with a film but was heated to a temperature of about 290° C., in the same manner as Examples 4C and 4D, after wet cleaning. The strengthened glass substrate of Example 4C was coated with a SiO₂ sol-gel, as described below, to provide a SiO₂ film having a thickness of 100 nm and then cured at a temperature of about 290° C. Example 4D was: 1) coated with a SiO₂ sol-gel, as described below, to provide a SiO₂ film having a thickness of about 100 nm; 2) cured at a temperature of about 290° C.; and 3) coated with an ITO film in the same manner as Examples 1A and 1C, to provide an ITO film having a thickness of about 85 nm. Accordingly, Example 4D included a strengthened glass substrate having a SiO₂ film having a thickness of about 100 nm, and a ITO film having a thickness of about 85 nm, wherein the SiO₂ film is disposed between the strengthened glass substrate and the ITO film.

Examples 4C and 4D were coated with a SiO₂ sol-gel that was prepared by:

1) adding 25 mL of TEOS (tetraethylorthosilicate) dropwise to 200 mL of methanol while stirring the methanol;
2) adding 25 mL of 0.01 M HCl in water dropwise to the methanol and TEOS mixture;
3) heating the methanol, TEOS, and HCl in water mixture was heated at about 70° C. under reflux for about 2 hours;
4) cooling the methanol, TEOS, and HCl in water mixture to room temperature to form mixture “A”; and
5) mixing 12.5 mL of mixture “A” with 5 mL of 2-propanol and 5 mL of 2-ethoxyethanol.

The SiO₂ sol-gel was then spin-coated on the surface of the cleaned strengthened glass substrates of Examples 4C and 4D at a spin speed of 450 RPM for 90 seconds. The strengthened glass substrates with the SiO₂ film were then cured at a temperature of about 290° C. for about 1.5 hours, as follows: 1) the temperature was increased to 290° C. at a rate of about 2° C./min; 2) the temperature was maintained at 290° C. for about 1.5 hours; and 3) the temperature was cooled at a rate of about 10° C./min. The resulting SiO₂ film was dense and stresses were formed in the SiO₂ coatings during curing, which contributes to the SiO₂ film having a low crack onset strain (or strain-to-failure) relative to the strengthened glass substrate.

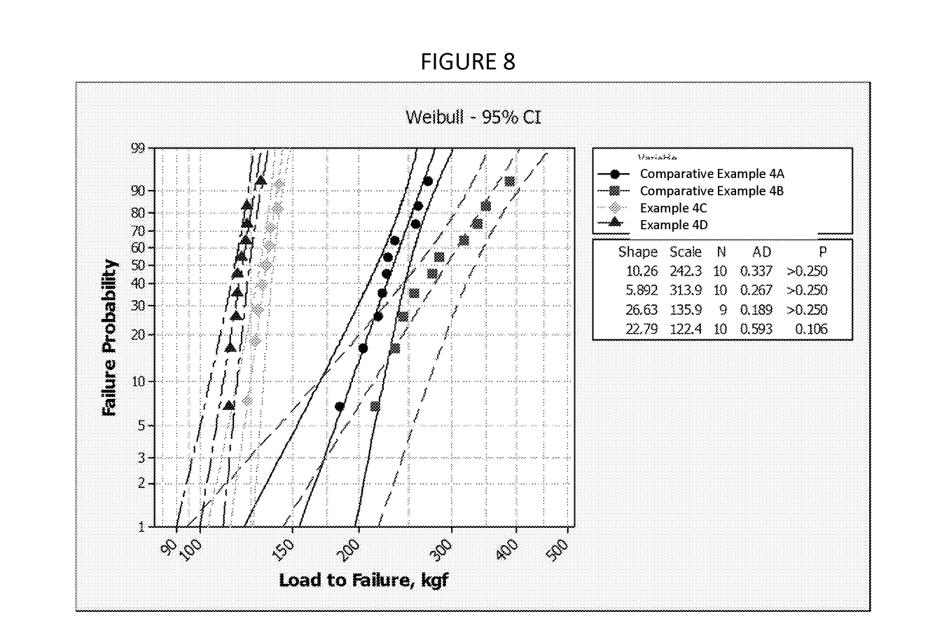

Examples 4A-4D were subjected to ring-on-ring testing t as in Examples 1A-1D. The results of the ring-on-ring testing are provided in the Weibull plot shown in FIG. 8. As shown in FIG. 8, the use of a SiO₂ film alone imparts a narrow and controlled failure strength distribution to the glass-film laminate. Without being bound by theory, the narrow and controlled failure strength distribution is believed to be caused, in part, by the low strain-to-failure of the SiO₂ sol-gel film, which is due to the tensile stresses generated in the film during sol-gel drying and curing. The Weibull moduli of the glass-film laminates according to Examples 4C and 4D were 22 and 26, respectively, whereas the Weibull moduli of Comparative Examples 4A and 4B were 5 and 10. The glass-film laminate of Example 4C exhibited an optical transmission of greater than about 90% over a portion of the visible wavelength spectrum, and an optical transmission haze of less than about 0.5%.

Moreover, the glass-film laminates of Examples 4C and 4D also exhibited a characteristic failure strength of 135.9 kgf, and 122.4 kgf, respectively, as indicated by the “scale” parameter of FIG. 8. Comparative Examples 4A and 4B exhibited a characteristic failure strength of 242.3 kgf and 313.9 kgf, respectively.

### Comparative Examples 5A-5C

Comparative Examples 5A-5C included glass-film laminates that utilize non-strengthened glass substrates or glass substrates that have not been strengthened as described herein. Each of Comparative Examples 5A-5C utilized commercially available glass substrates including aluminosilicate glass (Corning® 2319). The glass substrates had a thickness of 0.7 mm. The glass substrates of Comparative Examples 5A-5C were plasma cleaned, as in Examples 1A-1D.

After wet cleaning was completed, an ITO film was disposed on a surface of the glass substrates of Comparative Examples 5A and 5C in the same manner as Examples 1A and 1C. The ITO film of Example 5A had a thickness of about 30 nm and the ITO film of Example 5C had a thickness of about 85 nm. Each of Comparative Examples 5A-5C had a size of 2 inches by 2 inches.

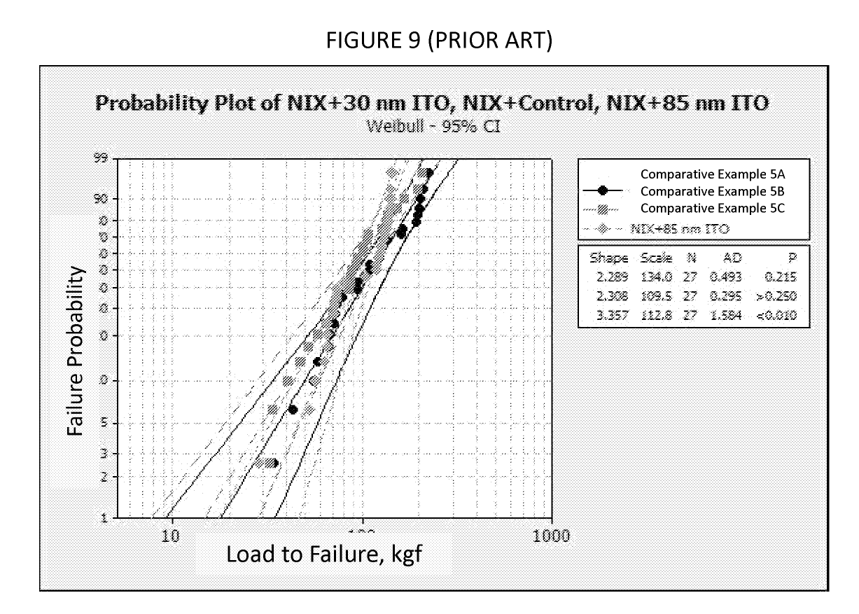

Each of Comparative Examples 5A-5C were subjected to ring-on-ring testing in the same manner as Examples 1A-1D. The results of the ring-on-ring testing are provided in the Weibull plot shown in FIG. 9.

As shown in FIG. 9, when a non-strengthened glass substrates are utilized, a narrow failure distribution (or steep Weibull modulus) is not created, even though a similar ITO film was utilized in Comparative Examples 5A and 5C as was used in Examples 1A and 1D. Indeed, the strain-to-failure distribution of Comparative Examples 5A and 5C is similar to the strain-to-failure distribution of Comparative Example 5B, which did not include any ITO film. Without wishing to be bound by theory, it is believed that the glass-film laminates (including a non-strengthened glass substrate and ITO film) of Comparative Examples 5A and 5C did not exhibit the narrow failure strength distributions of the glass-film laminates disclosed herein (that included strengthened glass substrates) because, in these Comparative Examples, the non-strengthened glass has an average strain-to-failure that is comparable to or lower than the average strain-to-failure of the ITO film. This illustrates that careful selection and control of the strengthened glass substrate 120 properties, such as strain-to-failure (which is influenced by surface quality, flaw population, strengthening methods, and other factors mentioned herein), and careful selection of the various film properties mentioned herein, with additional careful consideration of the film properties in relation to the strengthened glass substrate properties, can be influential in achieving desired controlled and narrow failure strength distributions.

While the disclosure has been described with respect to a limited number of embodiments for the purpose of illustration, those skilled in the art, having benefit of this disclosure, will appreciate that other embodiments can be devised which do not depart from the scope of the disclosure as disclosed herein. Accordingly, various modifications, adaptations and alternatives may occur to one skilled in the art without departing from the scope of the present disclosure.

1. An article comprising:
a strengthened glass substrate having a first major surface, a second major surface and an average substrate strain-to-failure at one or both of the first major surface and the second major surface; and
a first film disposed on the first major surface having an average film strain-to-failure less than the average strengthened glass substrate strain-to-failure,
wherein the article has a Weibull modulus of greater than about 10, as measured by ring-on-ring testing.

2. The article of claim 1, wherein the film is adhered to the strengthened glass substrate such that the film does not exhibit visible delamination from the strengthened glass substrate, when observed under an optical microscope, after indentation with a Berkovich diamond indenter using a non-zero load up to about 40 grams.

3. The article of claim 1, wherein the film comprises at least one of an IR blocking layer, a UV blocking layer, a conducting layer, a semiconducting layer, an electronics layer, a thin-film-transistor layer, a touch-sensing layer, an image-display layer, a fluorescent layer, a phosphorescent layer, a light-emitting layer, a wavelength-selective reflecting layer, a heads-up display layer, a scratch-resistant layer, an anti-reflection layer, an anti-glare layer, a dirt-resistant layer, a self-cleaning layer, a barrier layer, a passivation layer, a hermetic layer, a diffusion-blocking layer, and a fingerprint resistant layer.

4. The article of claim 1, wherein the first film comprises oxides, oxynitrides, nitrides, carbides, siliceous polymers, semiconductors, transparent conductors, metals, or combinations thereof.

5. The article of claim 1, wherein the Weibull modulus is at least one of about 15 or greater, about 20 or greater, and about 50 or greater, as measured by ring-on-ring testing.

6. The article of claim 1, further comprising at least one second film disposed on the first film on the strengthened glass substrate, wherein at least one second film comprises at least one of an IR reflecting layer, a UV reflecting layer, a conducting layer, a semiconducting layer, an electronics layer, a thin film transistor layer, a touch-sensing layer, an image-display layer, a fluorescent layer, a phosphorescent layer, a light-emitting layer, a wavelength-selective reflecting layer, a heads-up display layer, a scratch-resistant layer, an anti-reflection layer, anti-glare layer, dirt-resistant layer, self-cleaning layer, barrier layer, passivation layer, hermetic layer, diffusion-blocking layer, and fingerprint resistant layer.

7. The article of claim 6, wherein the first film and at least one second film form a stack exhibiting a fracture toughness of about 10 MPa·m^{1/2} or less.

8. The article of claim 1, wherein the first film forms an interface with the strengthened glass substrate and exhibits a total net stress during flexural loading sufficient to bridge cracks present in the first film across the interface and into the strengthened glass substrate.

9. The article of claim 1, wherein the substrate critical strain-to-failure at the first major surface or the second major surface is greater than about 1%.

10. The article of claim 1, wherein the first film exhibits at least one of a fracture toughness of about 10 MPa·m^{1/2} or less, and a critical strain energy release rate (G_{IC}=K_{IC}²/E) of less than about 1 kJ/m².

11. The article of claim 1, wherein the article exhibits at least one of: an optical transmittance of about 20% or greater, over a portion of the visible wavelength range, and an optical transmission haze of about 10% or less.

12. An article comprising:
a strengthened glass substrate having a first major surface and a second major surface, the strengthened glass substrate having a fracture toughness; and
a first film disposed on the first major surface forming an interface with the glass substrate, the interface having an interfacial fracture toughness greater than about 50% of the substrate fracture toughness,
wherein the article has a Weibull modulus of greater than 20, as measured by ring-on-ring testing.

13. The article of claim 12, wherein the first film is adhered to the glass substrate such that the film does not exhibit visible delamination from the glass substrate, when observed under an optical microscope, after indentation with a Berkovich diamond indenter using a load of from about 4 to about 40 grams.

14. The article of claim 12, wherein the first film comprises at least one of an IR reflecting layer, a UV reflecting layer, a conducting layer, a semiconducting layer, an electronics layer, a thin-film-transistor layer, a scratch-resistant layer, an anti-reflection layer, an anti-glare layer, a dirt-resistant layer, a self-cleaning layer, a barrier layer, a passivation layer, a hermetic layer, a diffusion-blocking layer, and a fingerprint resistant layer.

15. The article of claim 1, wherein the first film exhibits a fracture toughness of about 10 MPa·m^{1/2} or less.

16. The article of claim 1, further comprising a second film disposed on the first film, wherein the first film has a critical strain energy release rate (G_{IC}=K_{IC}²/E) of less than about 1 kJ/m².

17. An article comprising:
a chemically strengthened glass substrate having a first major surface and a second major surface; and
a first film disposed on the first major surface, the first film having a critical strain energy release rate (G_{IC}=K_{IC}²/E) of about 0.5 kJ/m² or less,
wherein the first film is adhered to the glass substrate such that first the film does not exhibit visible delamination from the glass substrate, when observed under an optical microscope, after indentation with a Berkovich diamond indenter using a load in the range from about 4 grams to about 40 grams, and
wherein the article has a Weibull modulus of greater than 10, as measured by ring-on-ring testing.

18. An article comprising:
a chemically strengthened glass substrate having a first major surface and a second major surface and an average strain-to-failure value; and
a first film disposed on the first major surface forming an interface with the glass substrate, the first film having an average strain-to-failure value less than the substrate average strain-to-failure value and a critical strain energy release rate (G_{IC}=K_{IC}²/E) less than about 1.0 kJ/m²,
wherein the first film is adhered to the glass substrate such that the first film does not exhibit visible delamination from the glass substrate, when observed under an optical microscope, after indentation with a Berkovich diamond indenter using a load in the range from about 4 grams to about 40 grams, and
wherein the article exhibits an asymmetric flexural strength, an asymmetric impact resistance, or a combination thereof.

19. The article of claim 18, wherein the article exhibits at least one of: an optical transmittance of about 20% or greater, over a portion of the visible wavelength range, and an optical transmission haze of about 10% or less.

20. A method of forming a glass-film laminate having a Weibull modulus greater than 10, as measured by one of ring-on-ring testing, 4-point bend testing, and 3-point bend testing, comprising:
selecting a desired failure strength for the glass-film laminate;
providing a chemically strengthened glass substrate having a first major surface and a second major surface, the strengthened glass substrate having an average strain-to-failure value and a fracture toughness;
disposing a first film on the first major surface, wherein the first film includes a property selected from modulus, thickness, and residual stress, and exhibits an average strain-to-failure that is less than the substrate average strain-to-failure; and
controlling one of the first film properties to achieve the desired failure strength.
